(19) United States
(12) Patent Application Publication
(10) Pub. No.: US 2024/0014387 A1
(43) Pub. Date: Jan. 11, 2024

(54) ELECTRODE STRUCTURE FOR ANODE, MANUFACTURING METHOD THEREFOR, AND SECONDARY BATTERY COMPRISING SAME

(71) Applicant: INDUSTRY-UNIVERSITY COOPERATION FOUNDATION HANYANG UNIVERSITY ERICA CAMPUS, Ansan-si (KR)

(72) Inventors: Jung Ho Lee, Ansan-si (KR); Sambhaji Shivaji Shinde, Ansan-si (KR); Dong Hyung Kim, Ansan-si (KR); Sung Hae Kim, Ansan-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 18/472,618

(22) Filed: Sep. 22, 2023

Related U.S. Application Data
(63) Continuation of application No. PCT/KR2022/004100, filed on Mar. 23, 2022.

(30) Foreign Application Priority Data
Mar. 23, 2021 (KR) 10-2021-0037491
Mar. 23, 2022 (KR) 10-2022-0036288

(51) Int. Cl. H01M 4/36; H01M 4/38; H01M 4/134; H01M 4/1395; H01M 4/62; H01M 12/08; H01M 4/58; H01M 4/136; H01M 4/1397; H01M 4/04; H01M 10/42

(52) U.S. Cl. CPC H01M 4/366; H01M 4/38; H01M 4/134; H01M 4/1395; H01M 4/62; H01M 12/08; H01M 4/5815; H01M 4/582; H01M 4/136; H01M 4/1397; H01M 4/0402; H01M 10/4235; H01M 2004/027

(57) ABSTRACT

A method for manufacturing a secondary battery is provided. The method for manufacturing a secondary battery may comprise the steps of: preparing a metal substrate; surface treating the metal substrate to form a passivation layer comprising S and F; and using the metal substrate on which the passivation layer is formed as an anode to manufacture a secondary battery.

### CROSS REFERENCE TO RELATED APPLICATIONS

This is a continuation of PCT/KR2022/004100 (filed 23 Mar. 2022), which claims the benefit of Republic of Korea Patent Application KR 10-2022-0036288 (filed 23 Mar. 2022) and Republic of Korea Patent Application KR 10-2021-0037491 (filed 23 Mar. 2021). The entire disclosure of each of these priority applications is hereby incorporated by reference herein.

### BACKGROUND OF THE INVENTION

### 1. Field of the Invention

The present application relates to an electrode structure for a negative electrode, a method for manufacturing the same, and a secondary battery including the same.

### 2. Description of the Prior Art

As mid-to-large high-energy applications such as electric vehicles, energy storage systems (ESS) and the like are rapidly growing beyond the existing secondary batteries for small devices and home appliances, the market value of the secondary battery industry was only about 22 billion dollars in 2018, but is expected to grow to about 118 billion dollars by 2025. As such, in order for secondary batteries to be used as medium and large-sized energy storage media, there is a demand for price competitiveness, energy density and stability which are significantly improved more than a current level.

According to the technical needs, various electrodes for secondary batteries have been developed.

For example, Korean Unexamined Patent Publication No. 10-2019-0139586 discloses an electrode for a lithium-air battery, which includes a carbon nanotube and RuO2 deposited on a surface of the carbon nanotube, in which the RuO2 is deposited on a surface defect site of the carbon nanotube; the RuO2 has a particle size of 1.0 to 4.0 nm; and the RuO2 inhibits carbon decomposition at a surface defect site of the carbon nanotube and promotes the decomposition of Li2O2 formed on the surface of the carbon nanotube.

### SUMMARY OF THE INVENTION

One technical object of the present application is to provide an electrode structure for a negative electrode, a secondary battery including the same, and a method for manufacturing the same.

Another technical object of the present application is to provide an electrode structure for a negative electrode with a low manufacturing cost and a simple manufacturing process, a secondary battery including the same, and a method for manufacturing the same.

Still another technical object of the present application is to provide an electrode structure for a negative electrode with flexibility improved by controlling a ratio of surface area and thickness through a patterning process, a secondary battery including the same, and a method for manufacturing the same.

Still another technical object of the present application is to provide an electrode structure for a negative electrode with an improved charge/discharge capacity, a secondary battery including the same, and a method for manufacturing the same.

Still another technical object of the present application is to provide an electrode structure for a negative electrode with a long lifespan and high stability, a secondary battery including the same, and a method for manufacturing the same.

The technical objects of the present application are not limited to the above.

To solve the above technical objects, the present application may provide a method for manufacturing a secondary battery.

According to one embodiment, the method for manufacturing a secondary battery may include: providing a metal substrate; surface treating the metal substrate to form a passivation layer including S and F; and using the metal substrate on which the passivation layer is formed as a negative electrode to manufacture a secondary battery.

According to one embodiment, the passivation layer may further include N, O and C.

According to one embodiment, an SEI layer may be formed by using the passivation layer in a process of charging and discharging the secondary battery.

According to one embodiment, the passivation layer may have a thickness of 20-30 um.

According to one embodiment, the metal substrate may include zinc, and the secondary battery may include a zinc-air battery.

To solve the above technical objects, the present application may provide a secondary battery.

According to one embodiment, the secondary battery may include a positive electrode, a negative electrode disposed on the positive electrode and including a metal substrate having a passivation layer including S and F, and an electrolyte between the positive electrode and the negative electrode.

According to one embodiment, the secondary battery may include SEI formed by using the passivation layer including S and F in a process of charging and discharging the secondary battery.

According to one embodiment, the passivation layer may include a first passivation layer on a first surface of the metal substrate; and a second passivation layer on a second surface opposite to the first surface of the metal substrate.

According to one embodiment, a plurality of concave portions provided in a surface of the metal substrate may be included.

To solve the above technical objects, the present application may provide a method for manufacturing an electrode structure.

According to one embodiment, the method for manufacturing an electrode structure may include: mixing trimethylethyl ammonium hydroxide and acetonitrile and adding methyl trifluoromethanesulfonate to prepare Me3EtNOTF; dispersing Zn(OTF)2, Zn(TFSI)2, and Zn(FSI) in a solvent and adding Me3EtNOTF to prepare a mixed solution; and immersing a metal substrate in the mixed solution to form a passivation layer on the metal substrate.

According to one embodiment, the method for manufacturing an electrode structure may further include: forming a plurality of concave portions on a surface of the metal substrate by wet-treating or imprinting the metal substrate before immersing the metal substrate in the mixed solution.

According to one embodiment, the passivation layer may include Zn, S, and F.

An electrode structure according to an embodiment of the present application may include a metal substrate and a passivation layer including S and F disposed on the metal substrate. The passivation layer may include a compound of a metal element and sulfur of the metal substrate and a compound of the metal element and fluorine, and an SEI layer may be easily formed using the passivation layer in a process of charging and discharging a secondary battery using the electrode structure as a negative electrode. As a result, the charge/discharge efficiency, capacity, and life properties of the secondary battery may be improved.

In addition, a plurality of concave portions may be formed in a surface of the metal substrate, and flexibility and mechanical properties of the electrode structure may be improved by the plurality of concave portions.

### BRIEF DESCRIPTION OF THE DRAWINGS

FIG. 1 is a flowchart for explaining a method of manufacturing an electrode structure for a negative electrode according to an embodiment of the present application.

FIG. 2 is a view for explaining an electrode structure for a negative electrode according to an embodiment of the present application.

FIG. 3 is views for explaining a solid electrolyte of a metal-air battery according to an embodiment of the present application and a method for preparing the same.

FIG. 4 is a flowchart for explaining a method for manufacturing an electrode structure for a positive electrode of a metal-air battery according to an embodiment of the present application.

FIG. 5 is a view for explaining a process of manufacturing an electrode structure for a positive electrode of a metal-air battery according to an embodiment of the present application.

FIG. 6 is a view showing pictures of a surface of an electrode structure having a passivation layer according to Experimental Example 1-1 of the present application.

FIG. 7 is a graph showing a comparison of measured overpotential values of an electrode structure having a passivation layer and an XRD graph thereof according to Experimental Example 1-1 of the present application.

FIGS. 8 and 9 are views showing pictures of a surface of an electrode structure having a plurality of concave portions formed thereon according to Experimental Example 1-3 of the present application.

FIG. 10 is a view showing pictures of an electrode structure and SEM pictures of a surface thereof according to Experimental Examples 1-3 and 1-4 of the present application.

FIGS. 11 and 12 are views showing the results of EDS analysis on an electrode structure according to Experimental Example 1-3 of the present application.

FIG. 13 is a view showing SEM pictures of an electrode structure according to Experimental Example 1-4 of the present application.

FIGS. 14 and 15 are views showing SEM pictures of an electrode structure and the results of EDS analysis thereof according to Experimental Example 1-4 of the present application.

FIG. 16 is a graph showing the results of an XRD analysis on an electrode structure according to Experimental Example 1-2 of the present application.

FIG. 17 is a view for explaining a first composite fiber according to Experimental Example 2-2 of the present application, and a method for preparing the same.

FIG. 18 is a view for explaining a second composite fiber according to Experimental Example 2-3 of the present application, and a method for preparing the same.

FIG. 19 is a view for explaining a method for preparing a solid electrolyte according to Experimental Example 2-4 of the present application.

FIG. 20 is a view showing an SEM picture of a solid electrolyte prepared according to Experimental Example 2-4 of the present application.

FIG. 21 is a graph for explaining a change in charge/discharge properties of a metal-air battery including a solid electrolyte according to Experimental Example 2-4 of the present application depending on an external temperature condition.

FIG. 22 is a view showing results of measuring an ionic conductivity of a solid electrolyte including a third composite fiber according to Experimental Example 2-8 of the present application depending on a temperature.

FIG. 23 is a view showing results of measuring an ionic conductivity of a solid electrolyte including a functional fiber according to Experimental Example 2-9 of the present application depending on a temperature.

FIG. 24 is a view showing pictures of an electrode structure manufactured according to Experimental Example 1 of the present application.

FIG. 25 is an XRD graph of an electrode structure manufactured according to Experimental Example 3 of the present application.

FIG. 26 is a view showing SEM pictures of an electrode structure according to Experimental Example 3 of the present application.

FIG. 27 is a view showing TEM pictures of an electrode structure according to Experimental Example 3 of the present application.

FIG. 28 is a view showing a simulation and a lattice fringe image of an atomic structure of an electrode structure according to Experimental Example 3 of the present application.

FIG. 29 is a view showing an SEAD pattern of an electrode structure according to Experimental Example 3 of the present application.

### DETAILED DESCRIPTION OF THE EXEMPLARY EMBODIMENTS

Hereinafter, preferred embodiments of the present invention will be described in detail with reference to the accompanying drawings. However, the technical idea of the present invention is not limited to the embodiments described herein and may be embodied in other forms. The embodiments introduced herein are provided to sufficiently deliver the spirit of the present invention to those skilled in the art so that the disclosed contents may become thorough and complete.

In addition, in the various embodiments of the present specification, the terms such as first, second, and third are used to describe various elements, but the elements are not limited to the terms. These terms are used only to distinguish one element from another element. Accordingly, an element mentioned as a first element in one embodiment may be mentioned as a second element in another embodiment. Each of the embodiments described and illustrated herein also include their complementary embodiments. Further, the term “and/or” in the present specification is used to include at least one of the elements enumerated in the specification.

In the specification, the terms of a singular form may include plural forms unless otherwise specified. Further, the terms “including” and “having” are used to designate that the features, the numbers, the steps, the elements, or combinations thereof described in the specification are present, and are not to be understood as excluding the possibility that one or more other features, numbers, steps, elements, or combinations thereof may be present or added. In addition, the term “connection” used herein may include the meaning of indirectly connecting a plurality of components, and directly connecting a plurality of components.

Further, in the following description of the present invention, a detailed description of known functions and configurations incorporated herein will be omitted when it may make the subject matter of the present invention unnecessarily unclear.

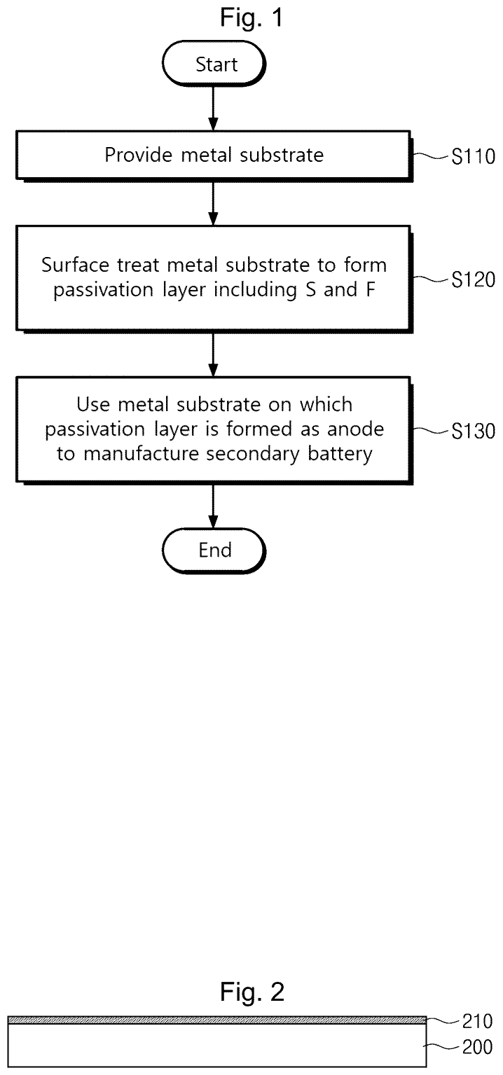

FIG. 1 is a flowchart for explaining a method of manufacturing an electrode structure for a negative electrode according to an embodiment of the present application, and FIG. 2 is a view for explaining an electrode structure for a negative electrode according to an embodiment of the present application.

Referring to FIGS. 1 to 2, a metal substrate 200 may be prepared (S110).

According to one embodiment, the metal substrate 200 may include zinc. Alternatively, according to another embodiment, the metal substrate 200 may include lithium, aluminum, magnesium, iron, etc.

The metal substrate 200 may include a first surface and a second surface facing the first surface, and the first surface and the second surface may be provided in a substantially flat state.

The metal substrate 200 may be surface-treated to form a passivation layer 210 including S and F (S120).

Although FIG. 2 shows that the passivation layer 210 is formed on the first surface of the metal substrate 200, the first surface and the second surface of the metal substrate 200 may be simultaneously surface-treated to form the passivation layer 210 on the first surface and the second surface.

The forming of the passivation layer 210 on the metal substrate 200 by surface-treating the metal substrate 200 may include: preparing S and F sources and a decomposition initiator for decomposing the S and F sources; preparing a surface treatment solution by providing the S and F sources to a solvent, adding the decomposition initiator, and stirring the resulting mixture; and immersing the metal substrate 200 in the surface treatment solution.

For example, the decomposition initiator may include Me₃EtNOTF, and may decompose the S and F sources. In this case, in the case of the decomposition initiator, trimethylethyl ammonium hydroxide may be mixed in acetonitrile, and then methyl trifluoromethanesulfonate may be added thereto, washed with ether and ethyl acetate, and vacuum-dried to prepare Me₃EtNOTF.

In addition, for example, the S and F sources may include at least one of zinc trifluoromethanesulfonate (Zn(OTF)2), zinc bistrifluoromethanesulfonate (Zn(TFSI)2), or zinc bis(fluorosulfonyl)imide (Zn(FSI)).

The passivation layer 210 may include S and F as described above. More specifically, the passivation layer 210 may include a compound of sulfur and a metal element of the metal substrate 200 and a compound of fluorine and the metal element. For example, when the metal substrate 200 is a zinc substrate, the passivation layer 210 may include ZnS and ZnF. In addition, the passivation layer 210 may further include N, O and C.

As described above, the passivation layer 210 may include a compound of sulfur and a metal element of the metal substrate 200 and a compound of fluorine and the metal element, and may be in an amorphous state. Accordingly, as a result of an XRD analysis on the metal substrate 200, a peak value corresponding to the compound of the metal element and sulfur (e.g., ZnS) and the compound of the metal element and fluorine (e.g., ZnF) may not be observed.

According to one embodiment, a plurality of concave portions may be arbitrarily arranged on the surface of the metal substrate 200 before the passivation layer 210 is formed by surface-treating the metal substrate 200. The plurality of concave portions may be formed in the first surface and the second surface of the metal substrate 200. Flexibility of the metal substrate 200 may be improved by the plurality of concave portions.

For example, the plurality of concave portions may be formed on the surface of the metal substrate 200 as the plurality of concave portions are arbitrarily arranged on a nanoscale by preparing a new mixed solution in which acetone, ethanol and water are mixed, and immersing the washed metal substrate 200 in the mixed solution.

Alternatively, as another example, the plurality of concave portions may be formed on the surface of the metal substrate 200 by using a silicon substrate having a plurality of pyramid structures as a mold, bringing the silicon substrate in contact with the metal substrate 200, and then mechanically applying pressure thereto, and the forming of the plurality of concave portions using the silicon substrate may be repeatedly performed.

After that, as described above, the passivation layer 210 may be formed on the metal substrate 200 by surface-treating the metal substrate 200 on which the plurality of concave portions are formed. In this case, the passivation layer 210 may be conformally formed along a surface profile of the metal substrate 200 on which the plurality of concave portions are formed.

Subsequently, referring to FIG. 1, a secondary battery may be manufactured using the metal substrate on which the passivation layer 210 is formed as a negative electrode.

According to one embodiment, the secondary battery may be a metal-air battery. In this case, a method for manufacturing a positive electrode and a solid electrolyte of the metal air battery will be described later.

As described above, the electrode structure for a negative electrode according to an embodiment of the present application may include the metal substrate 200 and the passivation layer 210 on the metal substrate 200. Thus, when a secondary battery is manufactured using the electrode structure, an SEI layer may be easily and stably formed using the passivation layer 210 in a process of charging and discharging the secondary battery. Accordingly, the secondary battery may have the improved charge/discharge efficiency and life properties.

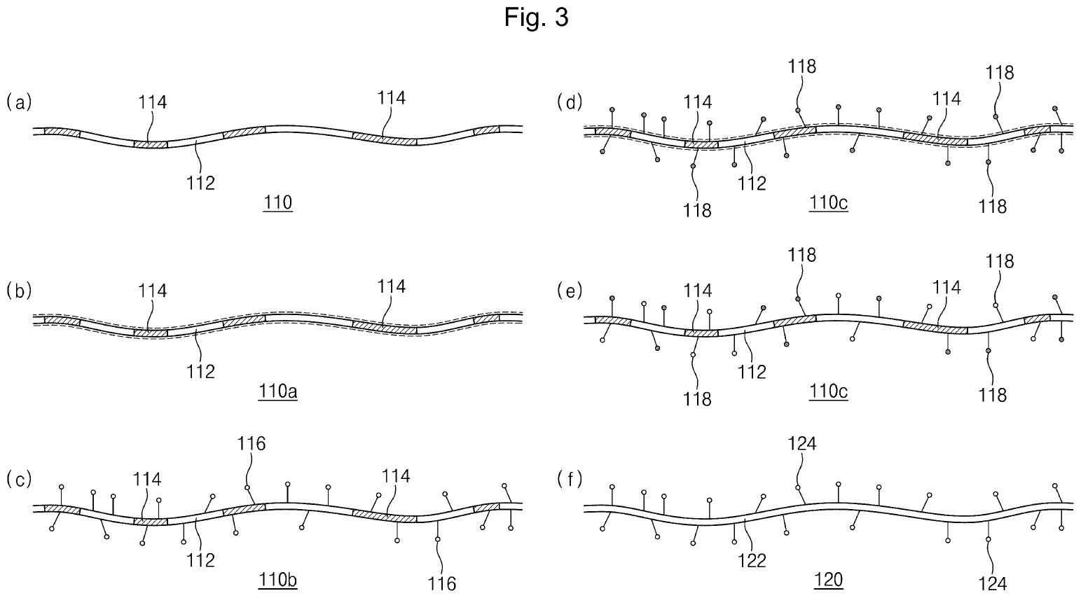

Subsequently, the solid electrolyte of the metal-air battery and the method for manufacturing the same will be described with reference to FIG. 3.

FIG. 3 is views for explaining a solid electrolyte of a metal-air battery according to an embodiment of the present application and a method for preparing the same.

Referring to FIG. 3, the method for preparing a solid electrolyte may include: preparing a chitosan derivative; preparing chitosan bound to cellulose from the chitosan derivative; and preparing a solid electrolyte by using the cellulose to which the chitosan is bound.

The chitosan derivative may be obtained by mixing a chitosan precursor in a solvent. According to one embodiment, the chitosan derivative may be obtained by adding a solubilizer to chitosan chloride and solvent. Accordingly, the chitosan chloride may be easily dissolved in the solvent, and the chitosan derivative may be easily provided to a medium to be described below, thereby easily preparing a cellulose to which chitosan is bound.

For example, the solvent may be aqueous acetic acid, and the solubilizer may include at least one of glycidyltrimethylammonium chloride, (2-aminoethyl)trimethylammonium chloride, (2-chloroethyl)trimethylammonium chloride, (3-carboxypropyl)trimethylammonium chloride, or (formylmethyl)trimethylammonium chloride.

The chitosan may have excellent thermal and chemical stabilities as well as a high ion conductivity, and may contain OH ions without a long-term loss. In addition, as described below, when used in a metal-air battery, a high compatibility with a zinc negative electrode and a compound structure of copper, phosphorus and sulfur may be achieved.

Alternatively, according to another embodiment, the chitosan derivative may be used as a commercial product.

The producing of the cellulose to which the chitosan is bound may include: preparing a culture medium having the chitosan derivative; and injecting and culturing a bacterial strain in the culture medium to produce a base composite fiber 110 including cellulose 112 to which chitosan 114 is bound as shown in (a) of FIG. 3. In this case, the cellulose 112 may be bacterial cellulose.

According to one embodiment, the cellulose 112 to which the chitosan 114 is bound may be prepared by culturing a bacterial pellicle in the culture medium and then desalinating the bacterial pellicle. The bacterial pellicle may be prepared by preparing a culture medium containing the chitosan derivative together with raw materials (for example, pineapple juice, peptone, disodium phosphate, and citric acid) for culturing yeast and bacteria, injecting a strain, and then culturing the same. For example, the strain may be Acetobacter xylinum.

The cultured bacterial pellicle may be washed, dried, desalted with an acidic solution (for example, HCl) and neutralized, and then the solvent may be removed to prepare the base composite fiber 110 including the cellulose 112 to which the chitosan 114 is bound. In the desalting process, the remaining Na, K, or cell shields and debris may be removed to prepare the cellulose 112 to which the chitosan 114 with high purity is bound.

In addition, the chitosan 114 may be chemically bound to the cellulose 112. Accordingly, in the cellulose 112 to which the chitosan 114 is bound, stretchable vibration corresponding to C—N may be observed during XPS analysis.

Unlike the above, according to another embodiment, the cellulose 112 to which the chitosan 114 is bound may be prepared by culturing a bacterial pellicle in the culture medium, washing with an alkali solution to remove unreacted bacterial cells, performing centrifugation and purification with deionized water, and evaporating the solvent. In other words, the desalting process using the acidic solution described above may be omitted.

According to one embodiment, a first composite fiber 110a may be prepared as a surface of the cellulose 112 to which the chitosan 114 is bound, that is, a surface of the base composite fiber 110 is oxidized by using an oxidizing agent.

Specifically, the preparing of the first composite fiber 110a may include adding the base composite fiber 110 to an aqueous solution containing an oxidizing agent to prepare a source solution, adjusting the pH of the source solution to be basic, adjusting the pH of the source solution to be neutral, and washing and drying the pulp in the source solution to prepare the first composite fiber 110a.

For example, the aqueous solution containing the oxidizing agent may be an aqueous TEMPO solution. Alternatively, as another example, the aqueous solution containing the oxidizing agent may include at least one of 4-hydroxy-TEMPO, (diacetoxyiodo)benzene, 4-amino-TEMPO, 4-carboxy-TEMPO, 4-methoxy-TEMPO, TEMPO methacrylate, 4-acetamido-TEMPO, 3-carboxy-PROXYL, 4-maleimido-TEMPO, 4-hydroxy-TEMPO benzoate, or 4-phosphonooxy-TEMPO.

The source solution may further include a sacrificial reagent and an additional oxidizing agent for the oxidation reaction of the base composite fiber 110. For example, the sacrificial reagent may include at least one of NaBr, sodium iodide, sodium bromate, sodium bromite, sodium borate, sodium chlorite, or sodium chloride, and the additional oxidizing agent may include at least one of NaClO, potassium hypochlorite, lithium hypochlorite, sodium chlorite, sodium chlorate, perchloric acid, potassium perchlorate, lithium perchlorate, tetrabutylammonium perchlorate, zinc perchlorate, hydrogen peroxide, or sodium peroxide.

According to one embodiment, the adjusting of the pH of the source solution to be basic, the pH of the source solution may be adjusted to 10. Accordingly, the oxidation reaction may be easily induced while a precipitate is minimized, and a degree of oxidation of the first composite fiber 110a may be improved as compared to the reaction condition of pH 8-9.

According to one embodiment, after the base composite fiber 110 and the sacrificial reagent are provided to the aqueous solution containing the oxidizing agent, the additional oxidizing agent may be provided. In addition, the additional oxidizing agent may be provided dropwise. Accordingly, an abrupt oxidation phenomenon of the base composite fiber 110 may be prevented, and as a result, the surface of the base composite fiber 110 may be uniformly and stably oxidized.

In addition, according to one embodiment, a second composite fiber 110b may be prepared by binding bromine to the surface of the cellulose 112 to which the chitosan 114 is bound and substituting a first functional group 116 including nitrogen with bromine.

The first functional group 116 may be represented by <Formula 1> below, and the first functional group 116 may be bound to the chitosan 114 and/or the cellulose 112.

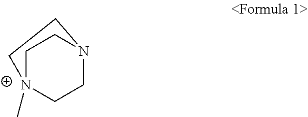

In other words, the second composite fiber 110b may have quaternary N.

Specifically, the preparing of the second composite fiber 110b may include preparing a first source solution by dispersing the base composite fiber 110 in a first solvent and adding a bromine source, preparing a reaction suspension by adding a coupling agent to the first source solution and causing a reaction therebetween, preparing a brominated base composite fiber by filtering, washing and freeze-drying the reaction suspension, preparing a second source solution by dispersing the brominated base composite fiber in a second solvent, adding a precursor of the first functional group 116 to the second source solution and causing a reaction therebetween, and preparing the second composite fiber 110b by filtering, washing and freeze-drying the reacted solution.

For example, the first solvent and the second solvent may be the same as each other, and may include at least one of N, N-dimethylacetamide, acetamide, acetonitrile, ethanol, ethylenediamine, diethyl ether, or benzaldehyde.

For example, the bromine source may include at least one of LiBr, sodium bromide, or potassium bromide.

For example, the coupling agent may include N-bromosuccinimide and triphenylphosphine. Bromine may be easily bound to a surface of the base composite fiber 110 by the coupling agent. Specifically, bromine in N-bromosuccinimide may be bound to the base composite fiber 110, and triphenylphosphine may reduce a bromine precursor (bromine source or N-bromosuccinimide) to improve a reaction rate.

As described above, after obtaining the base composite fiber brominated in the reaction suspension, the brominated base composite fiber may be freeze-dried. Accordingly, a loss of bromine in the brominated base composite fiber may be minimized, and a secondary reaction of bromine with other elements may be minimized.

For example, a precursor of the first functional group 116 may include 1,4-diazabicyclo[2.2.2]octane.

In addition, according to one embodiment, a third composite fiber 110c in which DNA 118 is bound to a surface of the cellulose 112 to which the chitosan 114 is bound, may be prepared.

The binding of the DNA 118 to the base composite fiber 110 having the cellulose 112 to which the chitosan 114 is bound may include providing the base composite fiber 110 including the cellulose 112 and the chitosan 114, adding oxidized chitosan to a solvent and mixing with the base composite fiber 110 to prepare a mixture, and adding the DNA 118 to the mixture and causing a reaction therebetween to bind the DNA 118 to a surface of the base composite fiber 110. The DNA 118 may be easily bound to the base composite fiber 110 via the oxidized chitosan. Specifically, the oxidized chitosan and the DNA 118 may be reacted, and then the reactant may be chemically bound to the base composite fiber 110, and the oxidized chitosan may be removed in a washing process.

According to one embodiment, the base composite fiber 110 may include the first composite fiber 110a that is formed as a surface of the base composite fiber 110 is oxidized and/or the second composite fiber 110b that is formed as the first functional group 116 is bound to a surface of the base composite fiber 110. In other words, as shown in (d) of FIG. 1, the DNA 118 may be bound to the first composite fiber 110a described with reference to (b) of FIG. 1 or to the surface of the second composite fiber 110b described with reference to (c) of FIG. 1. In other words, the third composite fiber 110c to which the DNA 118 is bound may be formed by binding the DNA 118 to at least one of the base composite fiber 110, the first composite fiber 110a, and the second composite fiber 110b. A low-temperature operation property of a solid electrolyte may be improved by the DNA 118.

In addition to the DNA 118, a carboxyl group or a DABCO group may be further bound to the surface of the third composite fiber 110c.

As described above, a solid electrolyte may be prepared using the cellulose 112 to which the chitosan 114 is bound (S130) The solid electrolyte may be prepared in the form of a membrane M in which the base composite fiber 110 including the cellulose 112 to which the chitosan 114 is bound forms a network. Accordingly, the solid electrolyte may have a plurality of pores provided therein, may have a high surface area, and may have excellent flexibility and mechanical property.

The solid electrolyte may be in a state in which a crystalline phase and an amorphous phase are mixed. More specifically, the solid electrolyte may have a ratio of an amorphous phase higher than a ratio of a crystalline phase. Accordingly, the solid electrolyte may have a high ionic mobility.

In addition, when the solid electrolyte is mounted on a metal-air battery, the metal-air battery may smoothly perform charge/discharge operations at low and high temperatures. In other words, the metal-air battery including the solid electrolyte according to an embodiment of the present application may smoothly operate at low and high temperatures, have a wide range of operating temperatures, and be used in various environments.

According to one embodiment, the solid electrolyte may be prepared by a gelatin process using the first composite fiber 110a and the second composite fiber 110b. In this case, the solid electrolyte may include the first composite fiber 110a and the second composite fiber 110b, in which the first composite fiber 110a and the second composite fiber 110b may be cross-linked to each other. Due to the first composite fiber 110a, the number of OH ions in the solid electrolyte may be increased, ionic conductivity may be improved, a negative charge density may be increased, and swelling resistance may be improved. In addition, due to the second composite fiber 110b, thermal stability may be improved due to an increase in molecular weight, ion exchange capacity may be improved to have a high moisture impregnation rate and a high swelling resistance, cross-linking binding strength with the first composite fiber 110a may be improved, and ion discerning selectivity with a specific solvent may be selectively high. Accordingly, a secondary battery including the solid electrolyte may have improved a charge/discharge property and a life property.

Specifically, the preparing of the solid electrolyte may include mixing the first composite fiber 110a and the second composite fiber 110b with a solvent to prepare a mixed solution, adding a crosslinking agent and an initiator to the mixed solution and causing a reaction therebetween to prepare a suspension, casting the suspension on a substrate and drying the same to prepare a composite fiber membrane, and performing an ion exchange process on the composite fiber membrane.

For example, the solvent may include a mixed solvent of methylene chloride, 1,2-propanediol, and acetone, the crosslinking agent may include glutaraldehyde, and the initiator may include N,N-diethyl-N-methyl-N-(2-methoxyethyl) ammonium bis(trifluoromethanesulfonyl)imide.

In addition, for example, an ion exchange process for the composite fiber membrane may include providing a KOH aqueous solution and a ZnTFSI aqueous solution to the composite fiber membrane. Accordingly, the content of OH ions in the solid electrolyte may be improved.

As described above, according to an embodiment of the present application, the solid electrolyte may include the membrane including at least one of the base composite fiber 110, the first composite fiber 110a, or the second composite fiber 110b.

A ratio of the chitosan 114 in the solid electrolyte may be easily controlled according to a content of the chitosan derivative provided in the culture medium. The crystallinity, ionic conductivity, and swelling ratio of the solid electrolyte may be controlled according to a ratio of the chitosan 114. Specifically, as the ratio of the chitosan 114 increases, the crystallinity of the solid electrolyte may gradually decrease.

According to one embodiment, the content of the chitosan 114 may be greater than 30 wt % and less than 70 wt %. If the content of the chitosan 114 is equal to or less than 30 wt % or equal to or greater than 70 wt %, the ionic conductivity of the solid electrolyte may be remarkably reduced, and the swelling ratio may be remarkably increased.

However, according to an embodiment of the present application, the ratio of the chitosan 114 in the solid electrolyte may be greater than 30 wt % and less than 70 wt %, and thus the solid electrolyte may have a low swelling ratio value while a high ionic conductivity property is maintained.

Alternatively, according to another embodiment, the solid electrolyte may be prepared using the third composite fiber 110c. Specifically, the solid electrolyte may be prepared by a method of mixing the third composite fiber (110c, for example, the first composite fiber 110a to which the DNA 118 is bound and/or the second composite fiber 110b to which the DNA 118 is bound) with a solvent, casting the solvent mixed with the third composite fiber 110c onto a substrate, drying the same to prepare a composite fiber membrane, and performing an ion exchange process (for example, ion exchange at room temperature at 1 M KOH aqueous solution and 0.1 M ZnTFSI for six hours, respectively) on the composite fiber membrane.

Alternatively, according to another embodiment, the functional fiber 120 shown in (f) of FIG. 1 may be added to the solid electrolyte including at least one of the base composite fiber 110, the first composite fiber 110a, the second composite fiber 110b, or the third composite fiber 110c.

The functional fiber 120 may have piperidone 122 as a backbone, and a terphenyl group 124 may be bound to a surface of the functional fiber 120.

The preparing of the solid electrolyte to which the functional fiber 120 is further added may include a method of mixing at least one of the base composite fiber 110, the first composite fiber 110a, the second composite fiber 110b, and the third composite fiber 110c with the functional fiber 120 in a solvent, casting the mixed solvent on a substrate, drying the same to prepare a composite fiber membrane, and performing an ion exchange process on the composite fiber membrane.

The functional fiber 120 may be further added to the solid electrolyte, thereby improving a high temperature operation property of the solid electrolyte as described below.

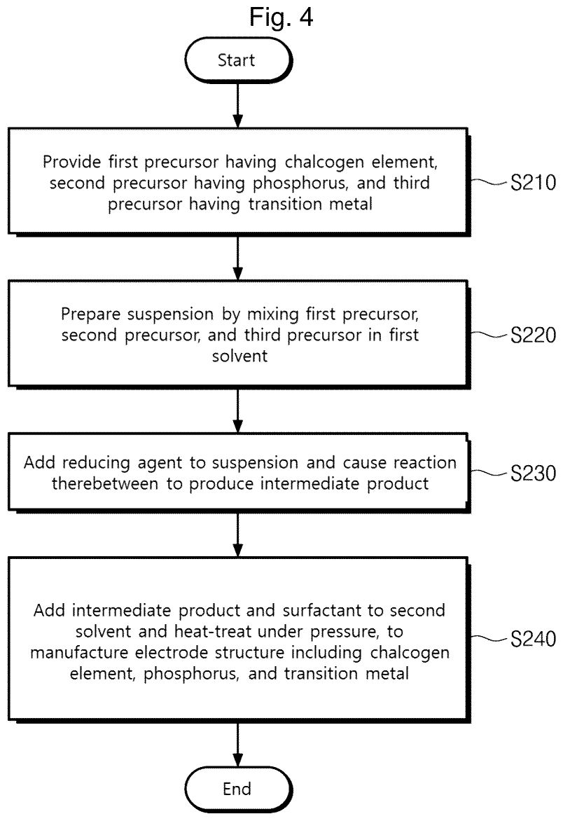

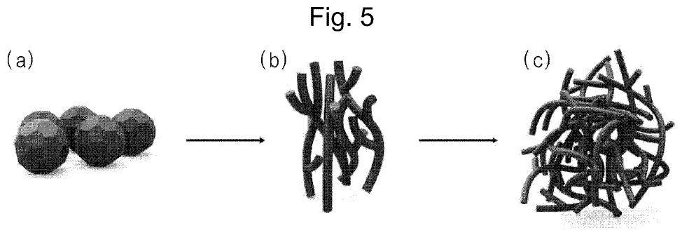

Subsequently, the electrode structure for the positive electrode of the metal-air battery described above and the method for manufacturing the same will be described with reference to FIGS. 4 and 5.

FIG. 4 is a flowchart for explaining a method for manufacturing an electrode structure for a positive electrode of a metal-air battery according to an embodiment of the present application, and FIG. 5 is a view for explaining a process of manufacturing an electrode structure for a positive electrode of a metal-air battery according to an embodiment of the present application.

Referring to FIGS. 4 and 5, a first precursor having a chalcogen element, a second precursor having phosphorus, and a third precursor having a transition metal may be prepared (S210) According to one embodiment, the chalcogen element may include sulfur. In this case, for example, the first precursor may include at least one of dithiooxamide, dithiobiuret, dithiouracil, acetylthiourea, thiourea, N-methylthiourea, bis(phenylthio)methane, 2-imino-4-thiobiuret, N,N′ ammonium sulfide, methyl methanesulfonate, sulfur powder, sulphates, N,N-dimethylthioformamide, Davy reagent methyl, sodium sulfide, thioacetamide, or sodium thiophosphate.

Alternatively, according to another embodiment, the chalcogen element may include at least one of oxygen, selenium, or tellurium.

For example, the second precursor may include at least one of tetradecylphosphonic acid, ifosfamide, octadecylphosphonic acid, hexylphosphonic acid, trioctylphosphine, phosphorus acid, triphenylphosphine, ammonium phosphide, pyrophosphates, Davy reagent methyl, cyclophosphamide monohydrate, phosphorus trichloride, phosphorus(V) oxychloride, thiophosphoryl chloride, phosphorus pentachloride, phosphorus pentasulfide, ifosfamide, triphenylphosphine, or sodium thiophosphate.

According to one embodiment, different heterogeneous types including phosphorus may be used as the second precursor. For example, a mixture of tetradecylphosphonic acid and ifosfamide at a ratio of 1:1 (M %) may be used as the second precursor. Accordingly, a stoichiometric ratio of the transition metal, phosphorus, and the chalcogen element may be controlled to 1:1:1. As a result, as will be described later, the positive electrode according to an embodiment of the present application may have a covellite structure, and the electrochemical properties of the positive electrode may be improved.

Alternatively, according to another embodiment, unlike the above, ifosfamide may be used alone, or phosphorus acid may be used alone as the second precursor.

According to one embodiment, the transition metal may include copper. In this case, for example, the third precursor may include at least one of copper chloride, copper(II) sulfate, copper(II) nitrate, copper selenide, copper oxychloride, cupric acetate, copper carbonate, copper thiocyanate, copper sulfide, copper hydroxide, copper naphthenate, or copper(II) phosphate.

Alternatively, according to another embodiment, the transition metal may include at least one of magnesium, manganese, cobalt, iron, nickel, titanium, zinc, calcium, aluminum, or tin.

The third precursor including the transition metal may include at least one of a transition metal chloride, a transition metal sulfide, or a transition metal nitride.

According to one embodiment, a bifunctional activity, which is a difference value between overpotentials of ORR and OER of the electrode structure to be described later, may be controlled by a type of the first precursor, a type of the second precursor, and a type of the transition metal of the third precursor.

A suspension may be prepared by mixing the first precursor, the second precursor, and the third precursor in a first solvent.

According to one embodiment, the first solvent may include at least one of alcohol (for example, ethanol, methanol, propanol, butanol, pentanol, etc.), DMF, oleic acid, oleylamine, 1-octadecene, trioctylphosphine, ethylenediamine, pyrrolidone, tributylamine, amine-based solvent, or deionized water.

According to one embodiment, a direction of crystal plane of the electrode structure to be described later may be controlled according to a type of the solvent and a mixing ratio. In other words, according to the type of the solvent and the mixing ratio, whether a crystal plane 101 is developed or not in the electrode structure may be controlled, and thus a bifunctional activity value, which is the electrochemical property of the electrode structure, may be controlled.

According to one embodiment, the solvent may be selected (for example, mixing ethanol and ethylenediamine at a volume ratio of 1:3) so that the crystal plane 101 may be developed in the electrode structure, thereby improving the electrochemical properties (for example, ORR, OER, HER) of the electrode structure.

Subsequently, referring to FIG. 1, an intermediate product may be produced by adding a reducing agent to the suspension and causing a reaction therebetween (S130).

For example, the reducing agent may include at least one of ammonium hydroxide, ammonium chloride, or tetramethylammonium hydroxide.

After the first precursor, the second precursor, and the third precursor are mixed in the solvent, the reducing agent may be provided to perform nucleation and crystallization as shown in (a) of FIG. 2 and prepare an intermediate including a plurality of stems as shown (b) of FIG. 5.

According to one embodiment, the suspension may be heat-treated to form the intermediate product. For example, the mixture to which the reducing agent is added may be heat treated under reflux at 120° C., and then washed with deionized water and ethanol.

The reducing agent may maintain pH and increase a reaction rate while performing a function of the reducing agent during heat treatment. Accordingly, the intermediate product having the plurality of stems may be easily prepared. For example, when the transition metal is copper and the chalcogen element is sulfur, the intermediate structure may be CuPS having a covellite crystal structure.

Alternatively, according to another embodiment, the intermediate product may be prepared by a method of adding the reducing agent to the suspension and then stirring the suspension at room temperature. In other words, the intermediate product may be prepared by a method of stirring at room temperature without an additional heat treatment.

An electrode structure including the chalcogen element, the phosphorus, and the transition metal may be prepared by a method of adding a surfactant to the intermediate product and performing heat treatment under pressure (S140).

According to one embodiment, the intermediate product and the surfactant may be added to a second solvent, and then a pressure heat treatment process may be performed.

The second solvent may be the same as the first solvent. For example, the second solvent may include at least one of alcohol (for example, ethanol, methanol, propanol, butanol, pentanol, etc.), DMF, oleic acid, oleylamine, 1-octadecene, trioctylphosphine, ethylenediamine, pyrrolidone, tributylamine, amine-based solvent, or deionized water.

For example, the surfactant may include at least one of Triton X-165, Triton X-100, H2SO4, HCl, hexamethylenetetramine, hexadecyltrimethylammonium bromide, ammonium sulfate, polyoxyethylene, dodecanol, tridecane, or stearic acid.

According to one embodiment, a bifunctional activity, which is a difference value between overpotentials of ORR and OER of the electrode structure, may be controlled by a type of the second precursor and a type of the surfactant.

In addition, according to one embodiment, a chalcogen element source having the chalcogen element may be further added along with the reducing agent. Accordingly, the chalcogen element lost in the reaction process may be supplemented by the chalcogen element source, and the electrode structure having a sponge structure in which a plurality of fibrillated fibers to be described later form a network may be easily formed.

For example, when the chalcogen element is sulfur, the chalcogen element source may include at least one of sodium bisulfite, sodium sulfate, sodium sulfide, sodium thiosulfate, sodium thiomethoxide, sodium ethanethiolate, or sodium methanethiolate.

In addition, according to one embodiment, a phosphorus source may be also added together with the chalcogen element source.

According to one embodiment, a process of mixing the intermediate product and the surfactant in the second solvent may be performed in a cooled state. The reaction rate may be prevented from excessively increasing due to the heat generated in the process of adding the second reducing agent, thereby improving the electrochemical properties of the electrode structure to be described later.

As described above, a plurality of branches may branch off from the plurality of stems as shown in (c) of FIG. 2 by adding the surfactant to the intermediate product and performing heat treatment under pressure, and thus the electrode structure having a sponge structure in which a plurality of fibrillated fibers form a network may be formed.

The electrode structure having a sponge structure may be immersed in liquid nitrogen after being washed with deionized water and ethanol. Accordingly, mechanical properties and flexibility of the electrode structure having a sponge structure may be improved. Alternatively, the process of immersing in liquid nitrogen may be omitted.

In addition, after being immersed in liquid nitrogen, the electrode structure having a sponge structure may be freeze-dried, and the remaining solvents may be removed to minimize a secondary reaction.

The electrode structure may include a membrane having a sponge structure, in which a plurality of fibrillated fibers having a plurality of branches branched off from the plurality of stems form a network as described above. Accordingly, the electrode structure may have a porous structure in which a plurality of pores having a size of 1 to 2 nm are provided, and may be flexible.

In addition, according to one embodiment, as described above, the type and ratio of the solvent mixed with the first precursor, the second precursor, and the third precursor may be controlled and thus a crystal plane 101 may be developed in the electrode structure. Accordingly, upon the XRD analysis of the electrode structure, a peak value corresponding to the crystal plane 101 may have a maximum value compared with a peak value corresponding to another crystal plane. Upon the XRD measurement, a peak value corresponding to a crystal plane 101 may be observed in a range of 2θ values of 19° to 21°.

The plurality of fibers forming the electrode structure may include a compound of the transition metal, phosphorus, and the chalcogen element. For example, when the transition metal is copper and the chalcogen element is oxygen, the fiber may be represented by the following <Formula 1>.

CuPₓS_{y} <Formula 1>

When the fiber forming the electrode structure is represented as above <Formula 1>, it may be x+y=1, 0.3≤x≤0.7, 0.3≤y≤0.7.

If, in above <Formula 1>, x is less than 0.3 or more than 0.7 and y is less than 0.3 or more than 0.7, ORR, OER, and HER properties of the electrode structure may be deteriorated, and thus the electrode structure may not react reversibly in a process of charging and discharging a metal-air battery including the electrode structure as a positive electrode, accordingly.

However, according to an embodiment of the present application, when the electrode structure is represented by CuPₓS_{y}, a composition ratio of P may be 0.3 or more and 0.7 or less and a composition ratio of S may be 0.3 or more and 0.7 or less. Accordingly, the ORR, OER, and HER properties of the electrode structure may be improved, and the charge/discharge property and life property of a metal-air battery, which includes the electrode structure as the positive electrode, may be improved.

When the metal-air battery including the electrode structure as a positive electrode performs charging and discharging, a lattice spacing of the fibers included in the electrode structure may be reversibly changed. Specifically, when the metal-air battery is charged, the lattice spacing may be 0.478 nm, and when the metal-air battery is discharged, the lattice spacing may be 0.466 nm. The lattice spacing of the fibers may be confirmed by the HRTEM.

According to an embodiment of the present application, the electrode structure having a membrane form in which the plurality of fibrillated fibers form a network according to a method of mixing the first precursor having the chalcogen element, the second precursor having phosphorus, and the third precursor having the transition metal, adding the reducing agent, and heat treating under pressure.

Accordingly, the electrode structure having high electrochemical properties may be manufactured by an inexpensive method.

In addition, the electrode structure may be manufactured by stirring and heat treating under pressure, and thus may be easily mass-produced and subjected to a simple manufacturing process, thereby providing the electrode structure for a positive electrode of a metal-air battery.

Hereinafter, a specific experimental example of the electrode structure for the positive electrode of the present application, and results of evaluating properties will be described accordingly.

Manufacturing of Electrode Structure According to Experimental Example 1-1

A zinc substrate was prepared as a metal substrate, and the zinc substrate was treated with a mixed solution containing hydrochloric acid and a passivation element to prepare a passivation layer on the zinc substrate.

Specifically, a mixed solution including S, F, I, Br, S and F, Mg, Ca, Ti, V, Mn, Fe, Co, Ni, Cu, W, Au, Ag, Hg, Mo, Al, Sn, and Te as passivation elements was prepared, respectively, to form a passivation layer on the zinc substrate.

In Experimental Example 1-1, copper chloride as a Cu source, magnesium chloride as a Mg source, calcium chloride as a Ca source, nickel chloride as a Ni source, iron chloride as a Fe source, manganese chloride as a Mn source, vanadium trichloride as a V source, silver nitrate as an Ag source, ammonium molybdate as a Mo source, hydrogen tetrachloroaurate tetrahydrate as an Au source, Zn TFSI, FSI and OTF as S and F sources, methyl thiocyanate as an S source, N, methyl immidazolium fluoride as an F source, potassium bromide as a Br source, titanium tetrachloride as a Ti source, cobalt chloride as a Co source, tungsten chloride as a W source, mercury chloride as a Hg source, aluminium trichloride as an Al source, tin chloride as a Sn source, and tellurium tetrachloride as a Te source were used.

Manufacturing of Electrode Structure According to Experimental Example 1-2

A mixed solution of acetone, ethanol and water was prepared, and a zinc substrate was immersed in the mixed solution and sonicated to wash the zinc substrate. After that, a plurality of concave portions were formed on a surface of the zinc substrate as the plurality of concave portions were arbitrarily arranged on a nanoscale again by preparing a new mixed solution in which acetone, ethanol and water are mixed, and immersing the washed zinc substrate in the mixed solution.

A decomposition initiator, S and F sources were prepared. Specifically, trimethylethyl ammonium hydroxide was mixed in acetonitrile, and then methyl trifluoromethanesulfonate was added thereto, washed with ether and ethyl acetate, and vacuum-dried to obtain Me₃EtNOTF as a decomposition initiator. In addition, zinc trifluoromethanesulfonate (Zn(OTF)₂), zinc bistrifluoromethanesulfonate (Zn(TFSI)₂), or zinc bis(fluorosulfonyl)imide (Zn(FSI)) were prepared as the S and F sources.

The S and F sources were dispersed in an aqueous solution, and the decomposition initiator was added and stirred. After that, the zinc substrate on which the plurality of concave portions were formed was immersed to form a passivation layer having a compound of Zn, S, F and N on a surface of the zinc substrate.

Then, the zinc substrate on which the passivation layer was formed was washed with deionized water and dried.

Manufacturing of Electrode Structure According to Experimental Example 1-3

An electrode structure was manufactured according to Experimental Example 1-2, and a plurality of concave portions were formed on a zinc substrate by being pressed on the zinc substrate as a silicon substrate having a plurality of pyramid-shaped concave portions without using the mixed solution.

Manufacturing of Electrode Structure According to Experimental Example 1-4

An electrode structure was manufactured according to Experimental Example 1-2, and a process of forming the plurality of concave portions was omitted.

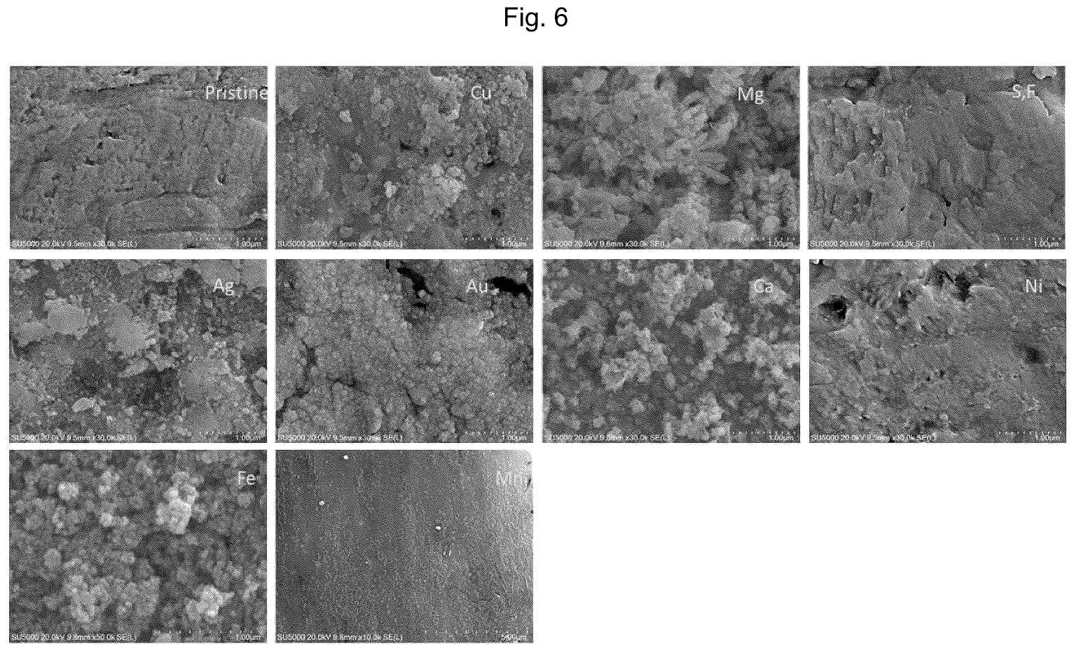

FIG. 6 is a view showing pictures of a surface of an electrode structure having a passivation layer according to Experimental Example 1-1 of the present application.

Referring to FIG. 6, according to Experimental Example 1-1, an SEM picture was taken of a passivation layer formed by using a mixed solution including Cu, Mg, S and F, Ag, Au, Ca, Ni, Fe, and Mn, as well as an upper surface of a zinc substrate before being treated with the mixed solution.

As can be understood from FIG. 6, it can be confirmed that the passivation layer including Cu, Mg, S and F, Ag, Au, Ca, Ni, Fe, and Mn is formed on the zinc substrate. In other words, it can be seen that the passivation layer may be easily formed on the zinc substrate by a simple process of immersing the zinc substrate in the mixed solution.

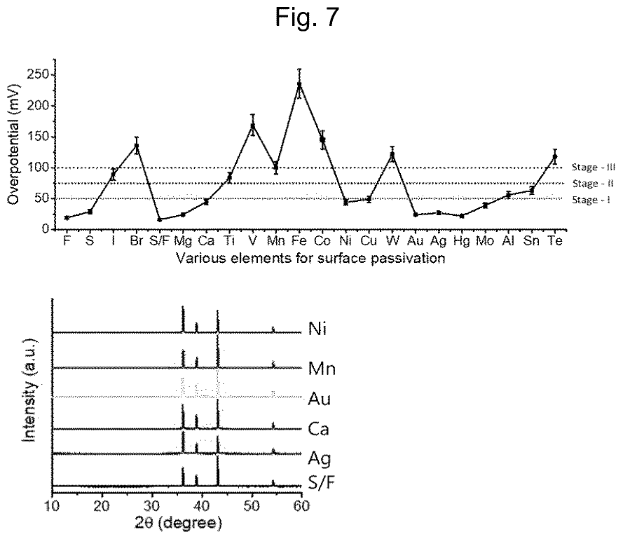

FIG. 7 is a graph showing a comparison of measured overpotential values of an electrode structure having a passivation layer and an XRD graph thereof according to Experimental Example 1-1 of the present application.

Referring to FIG. 7, according to Experimental Example 1-1, an overpotential value of a zinc electrode having a passivation layer formed by using a mixed solution including S, F, I, Br, S and F, Mg, Ca, Ti, V, Mn, Fe, Co, Ni, Cu, W, Au, Ag, Hg, Mo, Al, Sn, and Te was measured, and an XRD analysis was performed on the passivation layer including Ni, Mn, Au, Ca, Ag, and S/F.

As can be understood from FIG. 7, it can be seen that the passivation layer has a low overpotential value when including S and F, F, S, I, and Br, and it can be seen that the passivation layer has a low overpotential value even when using Au and Ag, which are precious metals.

In FIG. 7, the passivation layer may be defined as being optimized for a zinc electrode when having an overpotential value less than or equal to stage-I, the passivation layer may be defined as being suitable for a zinc electrode when having an overpotential value between stage-I and stage-II, the passivation layer may be defined as being usable for a zinc electrode when having an overpotential value between stage-II and stage-III, and the passivation layer may be defined as being unsuitable for a zinc electrode when having an overpotential value more than stage-III.

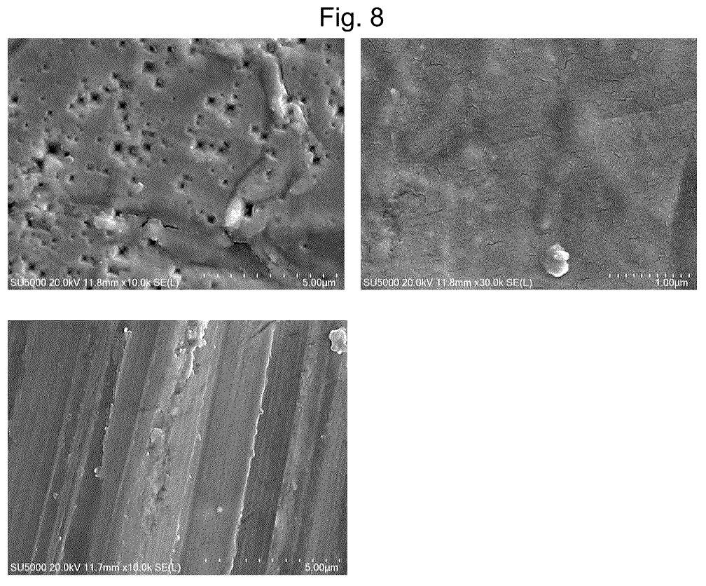

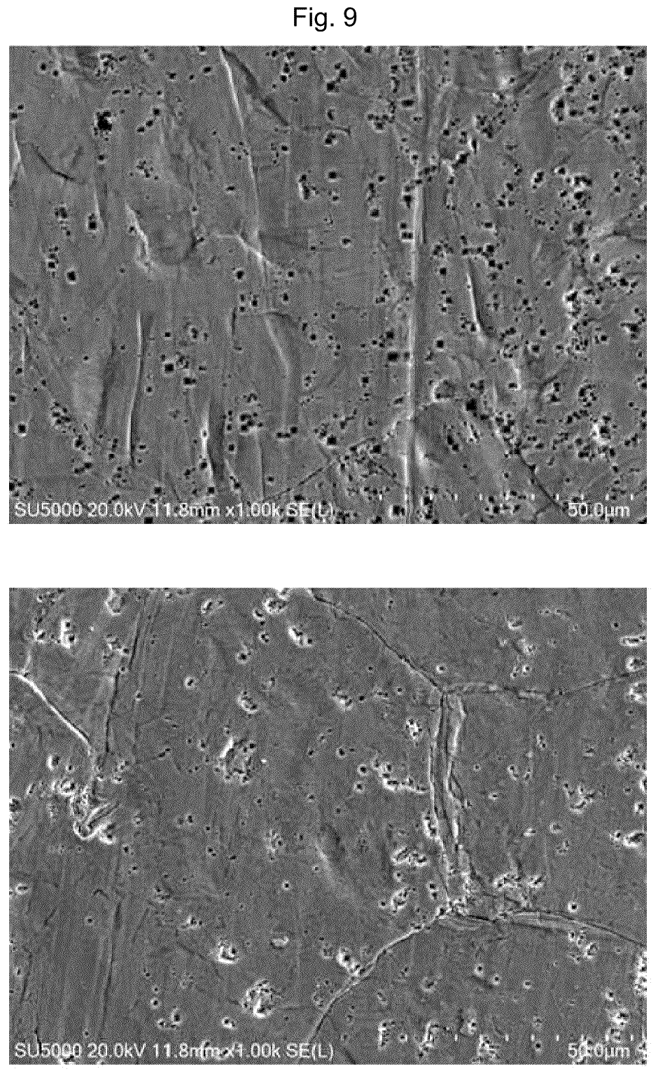

FIGS. 8 and 9 are views showing pictures of a surface of an electrode structure having a plurality of concave portions formed thereon according to Experimental Example 1-3 of the present application.

Referring to FIGS. 8 and 9, according to Experimental Example 1-3, the silicon substrate having the plurality of convex portions having a pyramid shape was prepared, the plurality of concave portions were formed on a surface of the zinc substrate by applying pressure to the zinc substrate using the silicon substrate, and an SEM picture was taken before the passivation layer was formed. FIG. 8 shows a case in which the pressure is applied once, and FIG. 9 shows a case in which the pressure is applied twice.

As can be understood from FIGS. 8 and 9, it can be confirmed that the plurality of concave portions may be easily formed on the surface of the zinc substrate by applying pressure to the zinc substrate using the silicon substrate having the plurality of convex portions.

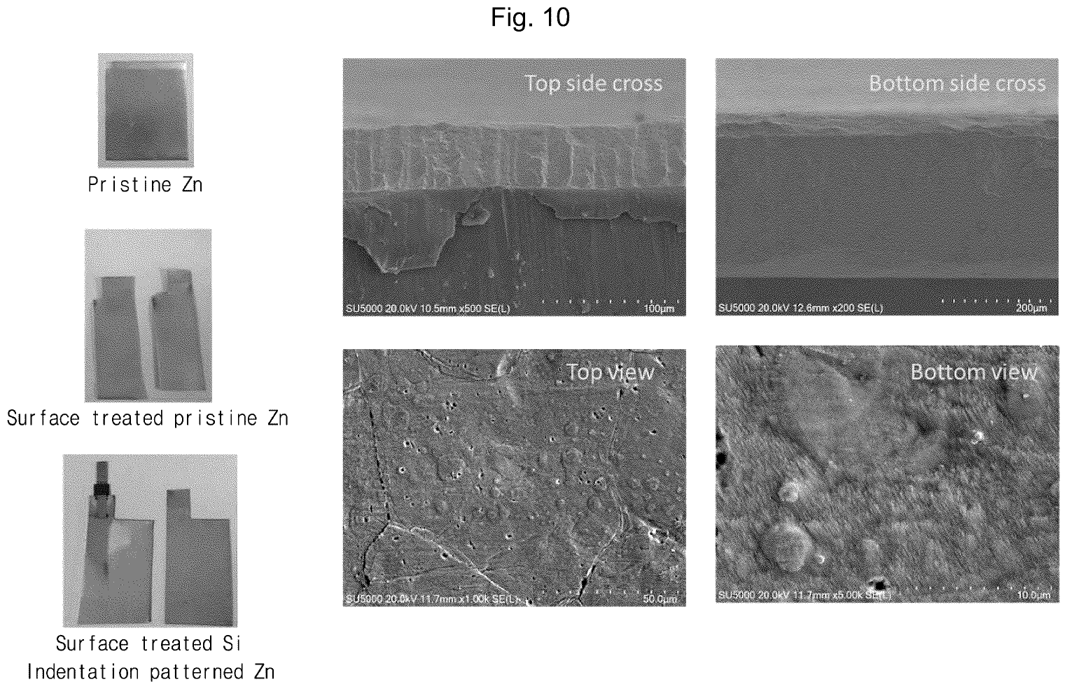

FIG. 10 is a view showing pictures of an electrode structure and SEM pictures of a surface thereof according to Experimental Examples 1-3 and 1-4 of the present application.

Referring to FIG. 10, in Experimental Example 1-2, a picture (pristine Zn) was taken before surface-treating a zinc substrate. In Experimental Example 1-4, a picture (surface treated pristine Zn) was taken by performing only the surface treatment without a process of forming a plurality of concave portions, and a picture (surface treated Si indentation patterned Zn) and an SEM picture were taken of the electrode structure prepared according to Experimental Example 1-3.

As can be understood from FIG. 10, it can be confirmed that the passivation layer was formed on the zinc substrate, and it can be seen that the passivation layer was formed on both the upper and lower surfaces of the zinc substrate.

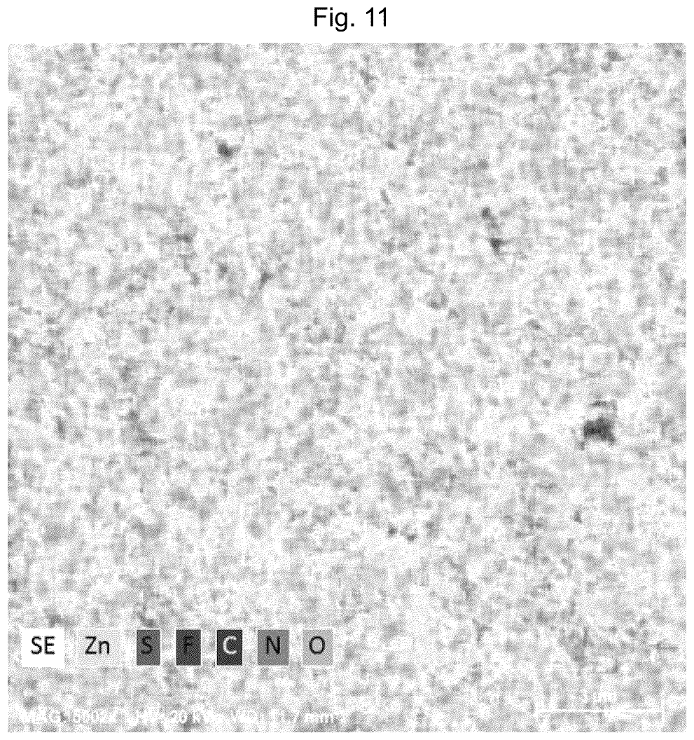

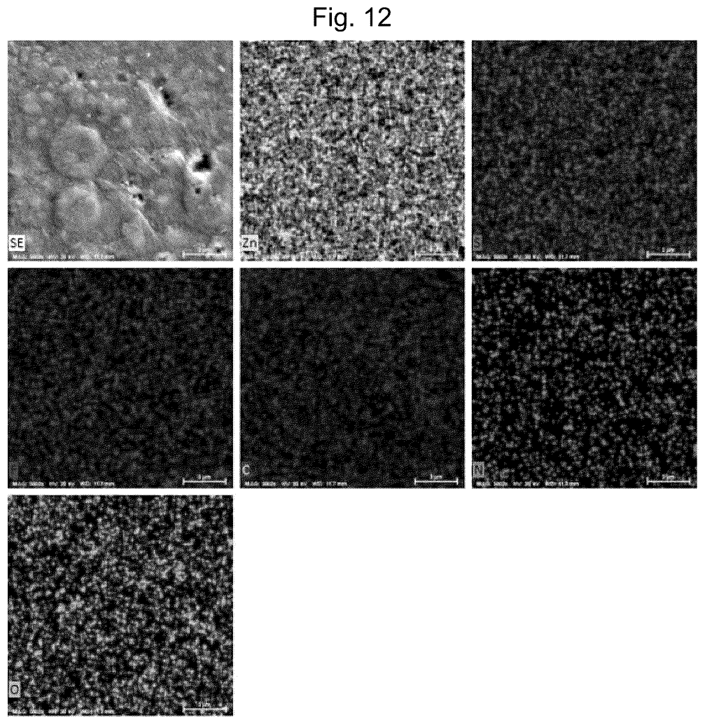

FIGS. 11 and 12 are views showing the results of EDS analysis on an electrode structure according to Experimental Example 1-3 of the present application.

Referring to FIGS. 11 and 12, an EDS analysis was performed on the electrode structure according to Experimental Example 1-3.

As can be confirmed from FIGS. 11 and 12, it can be confirmed that the passivation layer includes S, F and N, and S, F and N are substantially uniformly present. The passivation layer may allow an SEI layer to be easily formed in a process of charging and discharging a secondary battery.

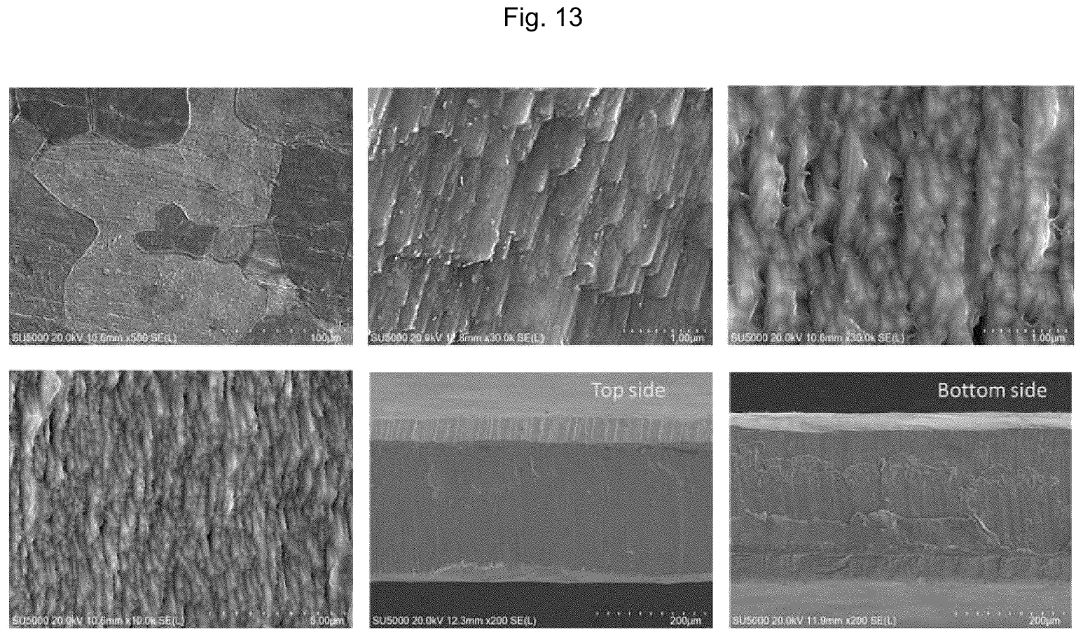

FIG. 13 is a view showing SEM pictures of an electrode structure according to Experimental Example 1-4 of the present application.

Referring to FIG. 13, an SEM picture was taken of the electrode structure according to Experimental Example 1-4, and as shown in FIG. 13, it can be confirmed that the passivation layer was formed on the upper and lower surfaces of the zinc substrate.

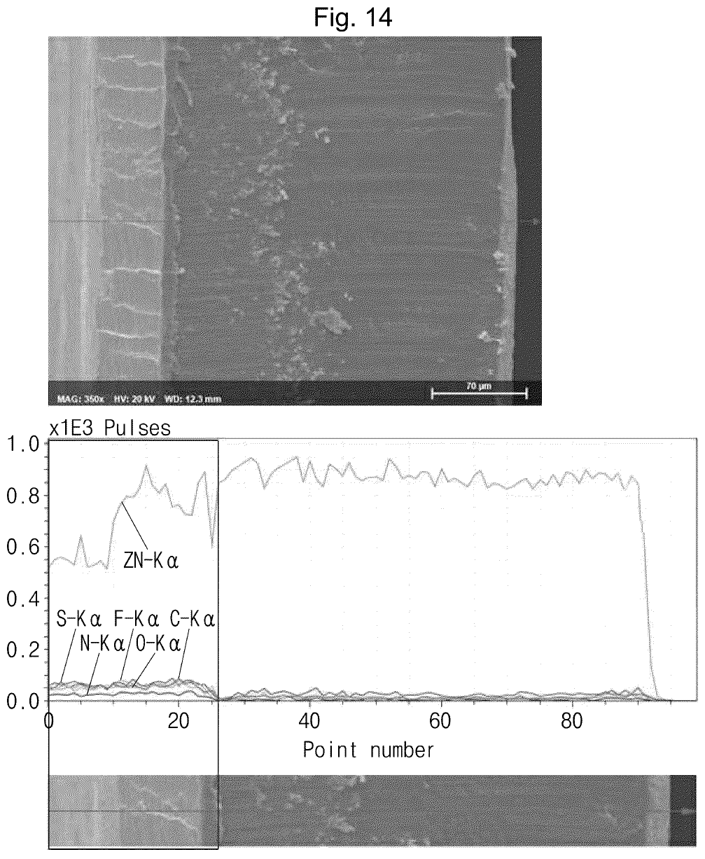

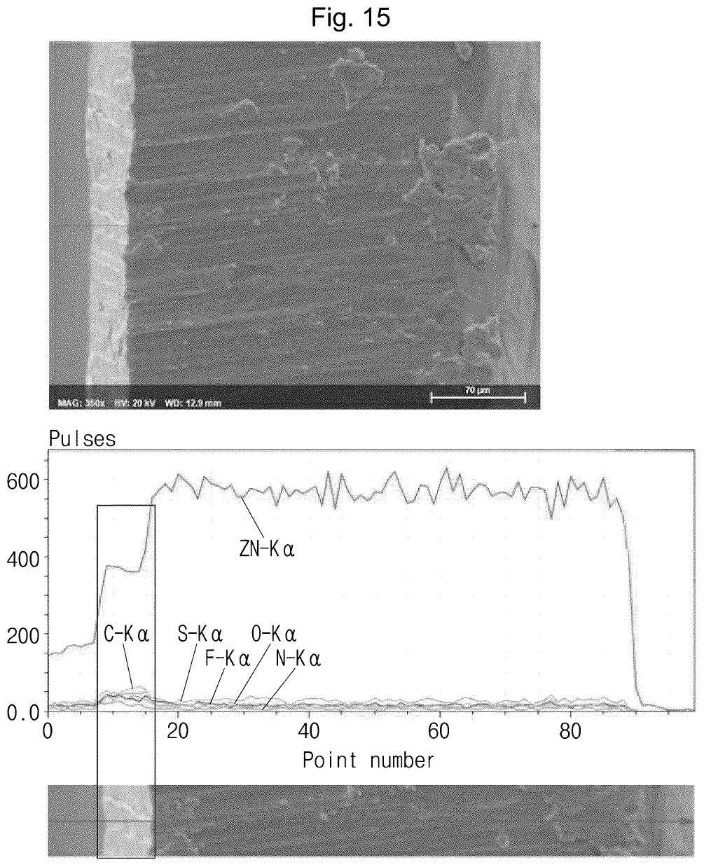

FIGS. 14 and 15 are views showing SEM pictures of an electrode structure and the results of EDS analysis thereof according to Experimental Example 1-4 of the present application.

Referring to FIGS. 14 and 15, an EDS analysis was performed on an SEM picture of the electrode structure according to Experimental Example 1-4. FIG. 14 shows a view corresponding to the passivation layer on an upper surface of the electrode structure according to Experimental Example 1-4, and FIG. 15 shows a view corresponding to the passivation layer on a lower surface of the electrode structure according to Experimental Example 1-5.

As can be confirmed from FIGS. 14 and 15, it can be confirmed that the passivation layers on the upper and lower surfaces of the zinc substrate are formed at a level of 30 um and 20 um, respectively, and formed of a compound of S, F and N.

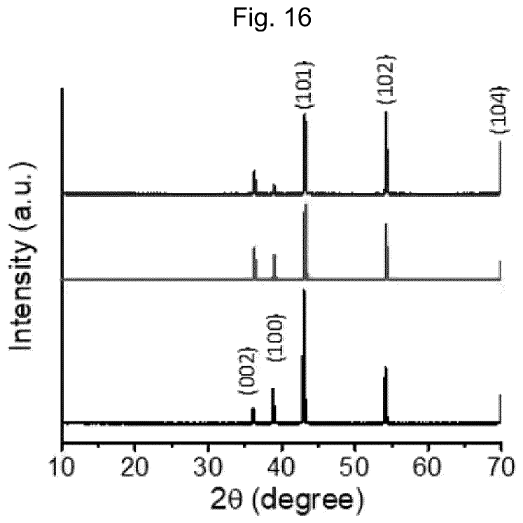

FIG. 16 is a graph showing the results of an XRD analysis on an electrode structure according to Experimental Example 1-2 of the present application.

Referring to FIG. 16, an XRS analysis was performed on the passivation layer of the electrode structure manufactured according to Experimental Example 1-2.

As shown in FIG. 16, it can be confirmed that the passivation layer does not have a crystal phase corresponding to ZnF and ZnS which are a compound of F and S as well as Zn of the zinc substrate, and exists in an amorphous state.

Hereinafter, a specific experimental example of the solid electrolyte of the metal-air battery of the present application, and results of evaluating properties will be described accordingly.

Preparing of Base Composite Fiber (CBC) According to Experimental Example 2-1

Acetobacter xylinum was provided as a bacterial strain, and a chitosan derivative was provided. The chitosan derivative was prepared by dissolving 1 g of chitosan chloride in 1% (v/v) aqueous acetic acid, treating the resulting suspension with 1 M glycidyltrimethylammonium chloride at 65° C. for 24 hours in an N2 atmosphere, precipitating, and filtering multiple times with ethanol.

A Hestrin-Schramm (HS) culture medium containing pineapple juice (2% w/v), yeast (0.5% w/v), peptone (0.5% w/v), disodium phosphate (0.27% w/v), citric acid (0.015% w/v), and the chitosan derivative (2% w/v) was prepared and steam-sterilized at 121° C. for 20 minutes. In addition, Acetobacter xylinum was activated in a pre-cultivation Hestrin-Schramm (HS) culture medium at 30° C. for 24 hours, and then acetic acid was added to maintain pH 6.

After that, Acetobacter xylinum was cultured in the Hestrin-Schramm (HS) culture medium at 30° C. for seven days.

The harvested bacterial pellicle was washed with deionized water to neutralize the pH of the supernatant and dehydrated in vacuum at 105° C. The resulting cellulose was demineralized by using 1 N HCl for 30 minutes (a mass ratio of 1:15, w/v) to remove an excessive amount of reagent, and then was purified a plurality of times by centrifugation with deionized water until the supernatant reached a neutral pH. Finally, all solvents were evaporated at 100° C. to prepare a base composite fiber (chitosan-bacterial cellulose (CBC)).

Preparing of First Composite Fiber (oCBC) According to Experimental Example 2-2

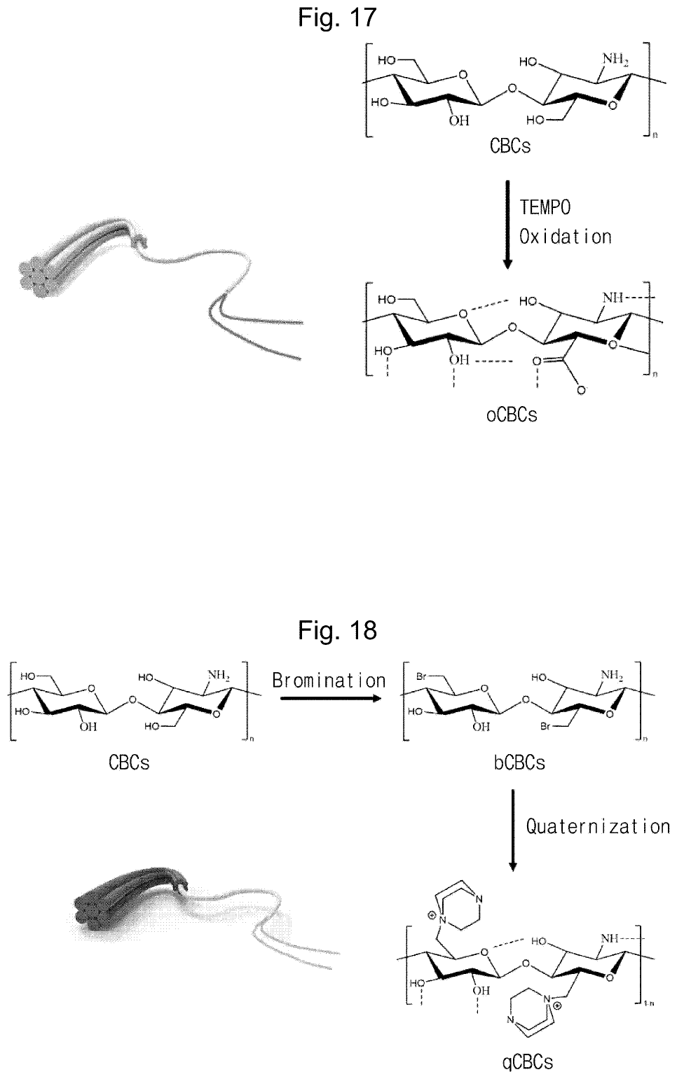

A first composite fiber (TEMPO-oxidized CBC (oCBCs)) that is formed as a surface of the base composite fiber is oxidized according to Experimental Example 2-1 was designed according to a method for conjugating a base composite fiber (CBC) of hydroxymethyl and ortho-para directing acetamido to an oxide of TEMPO by an oxidation reaction using 2,2,6,6-tetramethylpiperidin-1-oxyl (TEMPO), sodium bromide (NaBr) and sodium hypochlorite (NaClO) as shown in FIG. 17.

Specifically, 2 g of the base composite fiber dispersed in a 2 mM TEMPO aqueous solution was reacted with NaBr (1.9 mM). 5 mM NaClO was used as an additional oxidizing agent.

The reaction suspension was stirred with ultrasonic waves and subjected to a reaction at room temperature for three hours. The pH of the suspension was maintained at 10 by successive addition of 0.5 M NaOH solution. Then, 1 N HCl was added to the suspension to keep the pH neutral for three hours. The oxidized pulp produced in the suspension was washed three times with 0.5 N HCl, and the supernatant was brought to a neutral pH with deionized water.

The washed pulp was exchanged with acetone and toluene for 30 minutes and dried to evaporate the solvent, and finally a first composite fiber (oCBC) fiber was obtained.

As can be understood from FIG. 17, the surface of the base composite fiber may be oxidized.

Preparing of Second Composite Fiber (qCBC) According to Experimental Example 2-3

A second composite fiber (covalently quaternized CBC (qCBC)) that is formed as a first functional group having nitrogen is bound to the base composite fiber according to Experimental Example 2-1, was prepared according to a method for conjugating a brominated base composite fiber (CBC) and a quaternary amine group by a coupling agent using 1,4-diazabicyclo[2.2.2]octane, as shown in FIG. 18.

Specifically, 1 g of the base composite fiber dispersed in N,N-dimethylacetamide (35 ml) solution was reacted with LiBr (1.25 g) suspension while being stirred for 30 minutes. N-bromosuccinimide (2.1 g) and triphenylphosphine (3.2 g) were used as a coupling agent. The two reaction mixtures were stirred for 10 minutes and reacted at 80° C. for 60 minutes.

Then, the reaction suspension was cooled to room temperature, added to deionized water, filtered, rinsed with deionized water and ethanol, and freeze-dried to obtain a brominated base composite (bCBC) fiber.

The brominated base composite fiber was dissolved in 100 ml of N,N-dimethylformamide, and reacted with 1.2 g of 1,4-diazabicyclo[2.2.2]octane.

After that, the mixture was subjected to ultrasonic treatment for 30 minutes, and then reacted at room temperature for 24 hours. The resulting solution was mixed with diethyl ether, washed five times with diethyl ether/ethyl acetate, and freeze-dried to obtain a second composite fiber (covalently quaternized CBC (qCBC)).

As can be understood from FIG. 18, it can be confirmed that the first functional group having nitrogen is bound to the surface of the base composite fiber.

Preparing of Solid Electrolyte (CBCs) According to Experimental Example 2-4

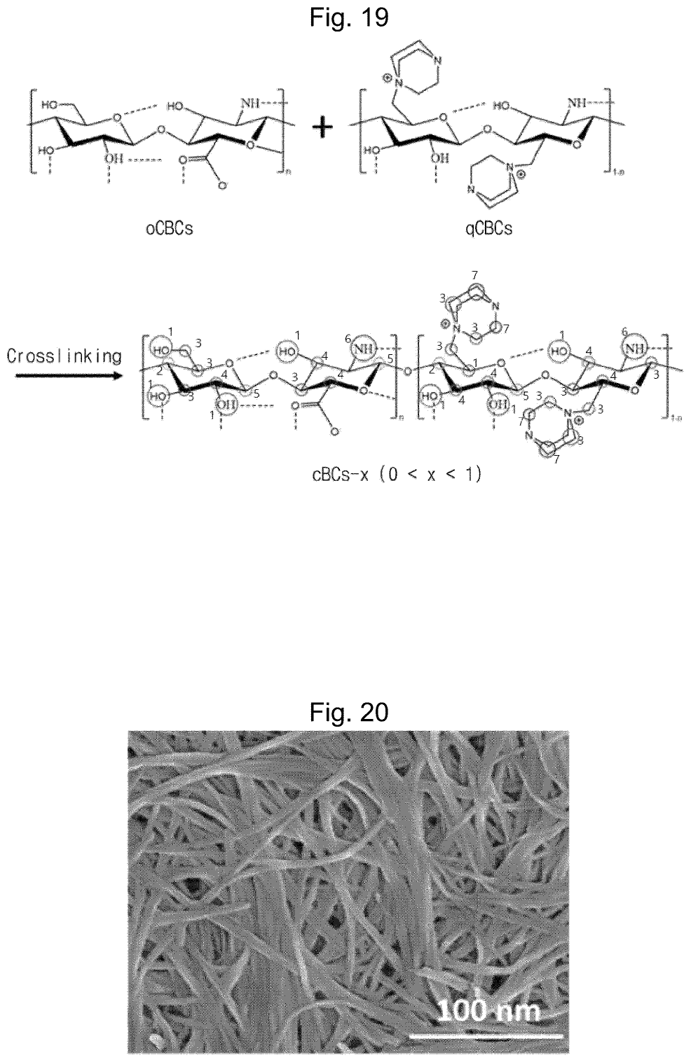

A solid electrolyte was prepared by a gelatin process using the first composite fiber (oCBC) according to Experimental Example 2-2 and the second composite fiber (qCBC) according to Experimental Example 2-3, as shown in FIG. 19. Specifically, the first composite fiber (oCBC) and the second composite fiber (qCBC) were dissolved in a mixture of methylene chloride, 1,2-propanediol and acetone (8:1:1 v/v/v %) at the same weight ratio by using ultrasonic waves, and then 1 wt % of glutaraldehyde as a crosslinking agent and 0.3 wt % of N,N-diethyl-N-methyl-N-(2-methoxyethyl) ammonium bis(trifluoromethanesulfonyl)imide as an initiator were added.

A vacuum chamber (200 Pa) was used to remove air bubbles from the gel suspension and cast on glass at 60° C. for six hours. A composite fiber membrane was peeled off while being coagulated with deionized water, rinsed with deionized water, and vacuum dried.

Solid electrolyte (CBCs) were prepared through ion exchange with 1 M KOH aqueous solution and 0.1 M ZnTFSI at room temperature for six hours, respectively. After that, washing and immersion processes were performed with deionized water in an N₂ atmosphere in order to avoid a reaction with CO2 and a carbonate formation.

As can be understood from FIG. 19, it can be confirmed that the first composite fiber (oCBC) and the second composite fiber (qCBC) are cross-linked to each other to form the solid electrolyte (CBCs).

FIG. 20 is a view showing an SEM picture of a solid electrolyte prepared according to Experimental Example 2-4 of the present application.

Referring to FIG. 20, an SEM picture was taken of the solid electrolyte prepared according to Experimental Example 2-4 as described above.

As can be understood from FIG. 20, it can be confirmed that a plurality of pores exist inside, and it can be confirmed that the bacterial cellulose fiber to which chitosan is bound is provided in a fibrillated form and a diameter is 5-10 nm.

It can be seen that a measured pore size is about 20-200 nm and the bacterial cellulose fiber to which chitosan is bound in the solid electrolyte forms a network with a high pore and a high surface area, thereby having a high strength against swelling.

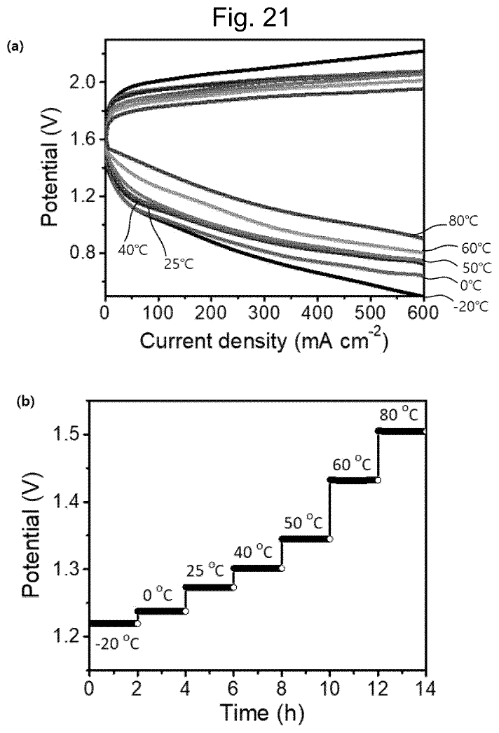

FIG. 21 is a graph for explaining a change in charge/discharge properties of a metal-air battery including a solid electrolyte according to Experimental Example 2-4 of the present application depending on an external temperature condition.

Referring to FIG. 21, a change in charge/discharge properties was measured while an external temperature was changed between −20° C. and 80° C. with regard to a metal-air battery using a solid electrolyte (CBCs) according to Experimental Example 2-4 as described above with reference to FIG. 19, a positive electrode of a compound structure of copper, phosphorus and sulfur, and a patterned negative electrode of zinc. (b) of FIG. 21 shows that a current density is measured at 25 mAcm⁻².

As can be understood from FIG. 21, it can be confirmed that a voltage value increases and has a low overpotential as a temperature increases. In other words, it can be confirmed that the secondary battery including the solid electrolyte according to Experimental Example 2-4 of the present application is stably driven in high and low temperature environments.

Preparing of Base Composite Fiber (CBC) According to Experimental Example 2-5 Acetobacter xylinum was provided as a bacterial strain, and a chitosan derivative was provided.

A Hestrin-Schramm (HS) culture medium containing pineapple juice (2% w/v), the chitosan derivative (2% w/v) and a nitrogen source (Daejeong X by Kisan Bio Co.) was prepared and Acetobacter xylinum was cultured in the Hestrin-Schramm (HS) culture medium at 30° C. for seven days.

The harvested bacterial pellicle was washed with water, washed with an alkali solution at room temperature to remove unreacted bacterial cells, and purified by centrifugation multiple times using deionized water. Finally, a remaining solvent was evaporated at 100° C. to prepare a base composite fiber (chitosan-bacterial cellulose (CBC)) according to Experimental Example 2-5.

Preparing of First Composite Fiber (oCBC) According to Experimental Example 2-6

A first composite fiber (oCBC) according to Experimental Example 2-6 was prepared by performing the same process as in the first composite fiber (oCBC) according to Experimental Example 2-2, but using the base composite fiber according to Experimental Example 2-5 instead of the base composite fiber according to Experimental Example 2-1.

Preparing of Second Composite Fiber (qCBC) According to Experimental Example 2-7

A second composite fiber (qCBC) according to Experimental Example 2-7 was prepared by performing the same process as in the second composite fiber (qCBC) according to Experimental Example 2-3, but using the base composite fiber according to Experimental Example 2-5 instead of the base composite fiber according to Experimental Example 2-1.

Preparing of Third Composite Fiber (DNA-CBC) According to Experimental Example 2-8

An enzyme solution containing an MES buffer of pH 5.7-6, cellulase R10, macerozyme R10, mannitol and KCl was prepared, and Cucumis sativus or Eruca sativa fragments were provided to the enzyme solution, and then the resulting mixture was infiltrated under vacuum in the dark for 30 minutes and decomposed at room temperature for three hours. After that, the resulting solution was diluted with an MMG solution (mannitol+MgCl2+MES, pH 5.7), and then the undecomposed material was purified using a stainless steel mesh, and centrifuged to obtain an extract. Additionally using an MMG solution, the obtained extract was dispersed again in the MMG solution and precipitated to extract pDNA.

A suspension was prepared by treating the extracted pDNA at a ratio of 3:1 to 3:4 w/w for six hours at room temperature using Alexa Fluor 488, and the resulting suspension was dialyzed for three days with deionized water using a 100 kDa MWCO dialysis membrane to remove free dye molecules, and finally centrifuged to stain pDNA. It is a process of staining pDNA with a fluorescent dye to further identify the presence or absence of cross coupling reaction of pDNA, and the process may be omitted.

Chitosan was oxidized with sodium hydroxide and deacetylated under N2 at 90° C. for eight hours, and then the resulting product was washed with deionized water several times and dried under vacuum to produce oxidized chitosan. A suspension was prepared by mixing 2 g of oxidized chitosan, 1 g of the first and second composite fibers (0.5 g of the first composite fiber and 0.5 g of the second composite fiber) per 100 ml of a solvent including 0.3% acetic acid.

The prepared suspension was mixed with the treated pDNA, stirred at room temperature for six hours, and dialyzed to remove unreacted materials, thereby preparing a third composite fiber (DNA-CBC) that is formed as DNA was coupled to the first composite fiber (oCBC) and the second composite fiber (qCBC).

After that, a covalent bond by conjugation of an amino group of chitosan with the first composite fiber (oCBC) and the second composite fiber (qCBC) by amide coupling was performed using N-ethyl-N′-(3-dimethylaminopropyl)-carbodiimide (EDC, 5 mg/ml) and N-hydroxysulfosuccinimide (sulfo-NHS, 5 mg/ml) to strengthen the bonding between DNA and cellulose of the first and second composite fibers (oCBC and qCBC), thereby improving durability.

Then, the reaction product was stirred at 30° C. for 16 hours, cooled, dialyzed and centrifuged, after which the third composite fiber (DNA-CBC) was added to DMSO, cast on a glass substrate, peeled off, and ion-exchanged using an aqueous 1 M KOH solution and 0.1 M ZnTFSI to prepare a solid electrolyte containing the third composite fiber (DNA-CBC).

Preparing of Functional Fiber According to Experimental Example 2-9

N-methyl-4-piperidone serving as a backbone of a polymer, 2,2,2-trifluoroacetophenone as a reaction catalyst, and p-terphenyl as a functional group were mixed with dichloromethane to prepare a mixture.

Trifluoroacetic acid as a reaction initiator and trifluoromethanesulfonic acid as a reaction rate controlling agent were added to the mixture in ice bath, and reacted for 24 hours to prepare a reaction product in which a p-terphenyl functional group was bound to piperidone, dispersed in ethanol, and then the prepared white precipitate was filtered, washed with water, and treated at 50° C. for 12 hours using K2CO3.

The resulting precipitate was washed with water and vacuum dried at 60° C. overnight, and the resulting product was suspended in DMSO and methyl iodide at room temperature for 12 hours. The suspension was poured into diethyl ether, washed with diethyl ether, and vacuum dried at 60° C., thereby preparing a functional fiber including piperidone.

A mixture of the first composite fiber (oCBC) according to Experimental Example 2-6 and the second composite fiber (qCBC) according to Experimental Example 2-7, and the dried product were dissolved in DMSO, cast on a glass plate, and peeled off with deionized water to prepare a solid electrolyte including the functional fiber according to Experimental Example 2-9. After that, the membrane was ion-exchanged at 1 M KOH, washed with DI water, and dried.

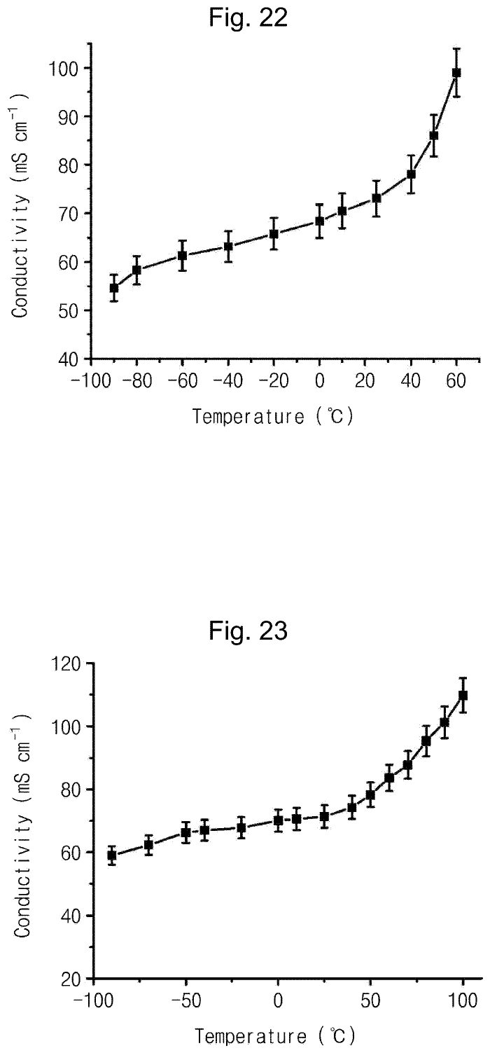

FIG. 22 is a view showing results of measuring an ionic conductivity of a solid electrolyte including a third composite fiber according to Experimental Example 2-8 of the present application depending on a temperature.

Referring to FIG. 22, with regard to the solid electrolyte including the third composite fibers according to Experimental Example 2-8 of the present application, the ionic conductivity for OH ions was measured while a temperature was changed between −90° C. and 60° C.

As can be understood from FIG. 22, it was confirmed that the solid electrolyte prepared using the third composite fiber including DNA maintains a high ionic conductivity between −90° C. and 60° C. In other words, it can be confirmed that the above-mentioned solid electrolyte has relatively excellent ionic conductivity in a low-temperature environment compared to the solid state electrolyte according to Experimental Example 1-4 prepared using the first composite fiber (oCBC) and the second composite fiber (qCBC) to which DNA was not coupled. In conclusion, it can be seen that preparing a solid electrolyte using the third composite fiber including DNA is an efficient method of improving a low-temperature operation property of the solid electrolyte.

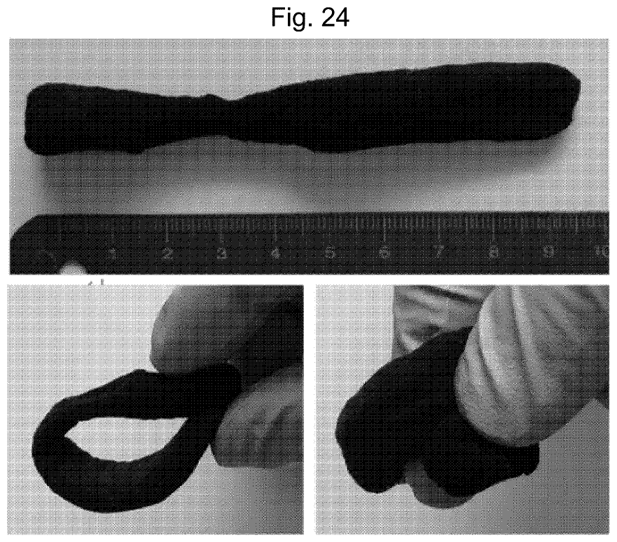

FIG. 23 is a view showing results of measuring an ionic conductivity of a solid electrolyte including a functional fiber according to Experimental Example 2-9 of the present application depending on a temperature.

Referring to FIG. 23, with regard to the solid electrolyte including the functional fiber according to Experimental Example 2-9 of the present application, the ionic conductivity for OH ions was measured while a temperature was changed between −90° C. and 100° C.

As can be understood from FIG. 23, it can be confirmed that the solid electrolyte prepared using the functional fiber including piperidone maintained a high ionic conductivity between −90° C. and 100° C. In other words, it can be confirmed that the above-mentioned solid electrolyte has relatively excellent ionic conductivity in a high-temperature environment compared to the solid state electrolyte according to Experimental Example 2-4 prepared using the first composite fiber (oCBC) and the second composite fiber (qCBC), which do not include a functional fiber containing piperidone, as well as the solid electrolyte according to Experimental Example 2-8 prepared using the third composite fiber (DNA-CBC). In conclusion, it can be seen that preparing a solid electrolyte using the functional fiber including piperidone is an efficient method of improving a high-temperature operation property of the solid electrolyte.

Manufacturing of Electrode Structure for Positive Electrode and Secondary Battery According to Experimental Example 3

Dithiooxamide was prepared as a first precursor having sulfur, a mixture of tetradecylphosphonic acid and ifosfamide (1:1 M %) was prepared as a second precursor having phosphorus, copper chloride was prepared as a third precursor having copper, and a mixture of ethanol and ethylenediamine (1:3 v/v %) was prepared as a solvent.

The first to third precursors were added to the solvent and stirred to prepare a suspension.

After that, 2.5 M % ammonium hydroxide was added as a reducing agent, stirred for two hours, and heat treated at 120° C. for six hours, after which an intermediate product was obtained, washed with deionized water and ethanol, and dried under vacuum at 50° C.

In an ice bath, the intermediate product was mixed and stirred in 20 ml of deionized water with Triton X-165 as a surfactant and sodium bisulfite as an sulfur element source. After that, the resulting mixture was heat treated under pressure at 120° C. for 24 hours and mixed in M-methyl-pyrrolidone to prepare a slurry, which was then coated and peeled off, thereby preparing a membrane in which a plurality of fibrillated fibers formed of a compound of copper, phosphorus and sulfur form a network.

The membrane was washed with deionized water and ethanol to adjust to neutral pH, stored at −70° C. for two hours, immersed in liquid nitrogen, and freeze-dried in vacuum, so as to prepare a CuPS electrode structure according to Experimental Example 3 in which a crystal plane 101 is developed.

In the process of manufacturing the electrode structure according to Experimental Example 3, a ratio of the first precursor having sulfur and the second precursor having phosphorus was controlled to adjust a ratio of P and S in CuPS at 0.1:0.9, 0.2:0.8, 03:0.7, 0.5:0.5, 0.7.0.3, and 0.9:0.1, respectively.

A zinc-air battery according to Experimental Example 3 was manufactured by using the CuPS electrode structure according to Experimental Example 3 as a positive electrode, laminating a solid electrolyte according to Experimental Example 2-4, and a patterned zinc negative electrode.

FIG. 24 is a view showing pictures of an electrode structure manufactured according to Experimental Example 1 of the present application.

Referring to FIG. 24, the electrode structure (CuP_{0.5}S_{0.5}) manufactured according to Experimental Example 3 described above was photographed.

As shown in FIG. 24, it can be confirmed that the electrode structure according to Experimental Example 1 has a length of about 10 cm and is flexible.

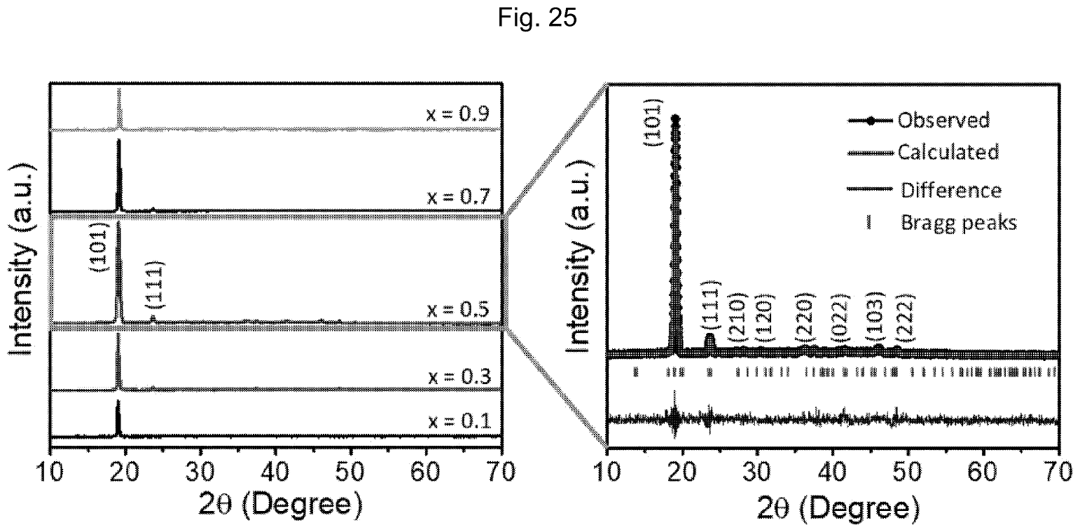

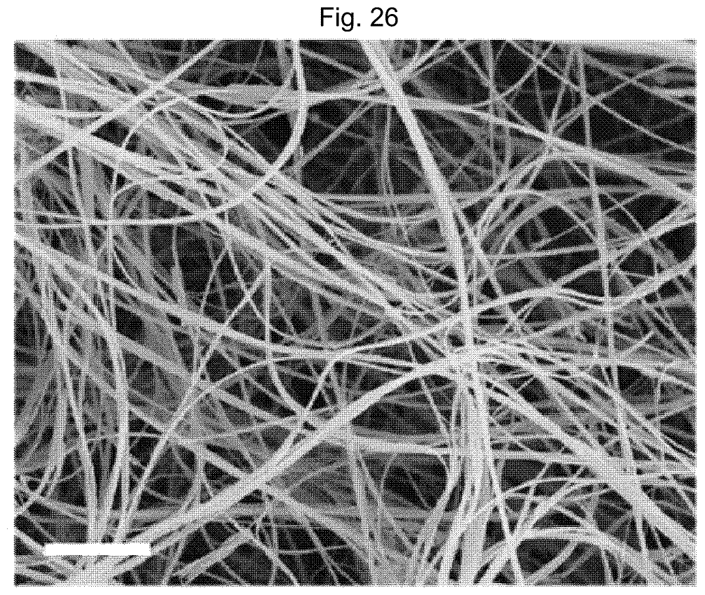

FIG. 25 is an XRD graph of an electrode structure manufactured according to Experimental Example 3 of the present application.

Referring to FIG. 25, an XRD measurement was performed for a CuPS electrode structure having various P and S composition ratios according to Experimental Example 3.

As can be confirmed from FIG. 25, it can be confirmed that a pattern changes according to a composition ratio of P and S in the CuPS electrode structures according to Experimental Examples, and it can be seen that a size of a peak corresponding to the crystal plane 101 is larger than a size of a peak corresponding to another crystal plane.

In addition, it can be seen that the CuPS positive electrode of Experimental Example 3 has a covellite phase with an orthorhombic crystal structure Pnm21 space group.

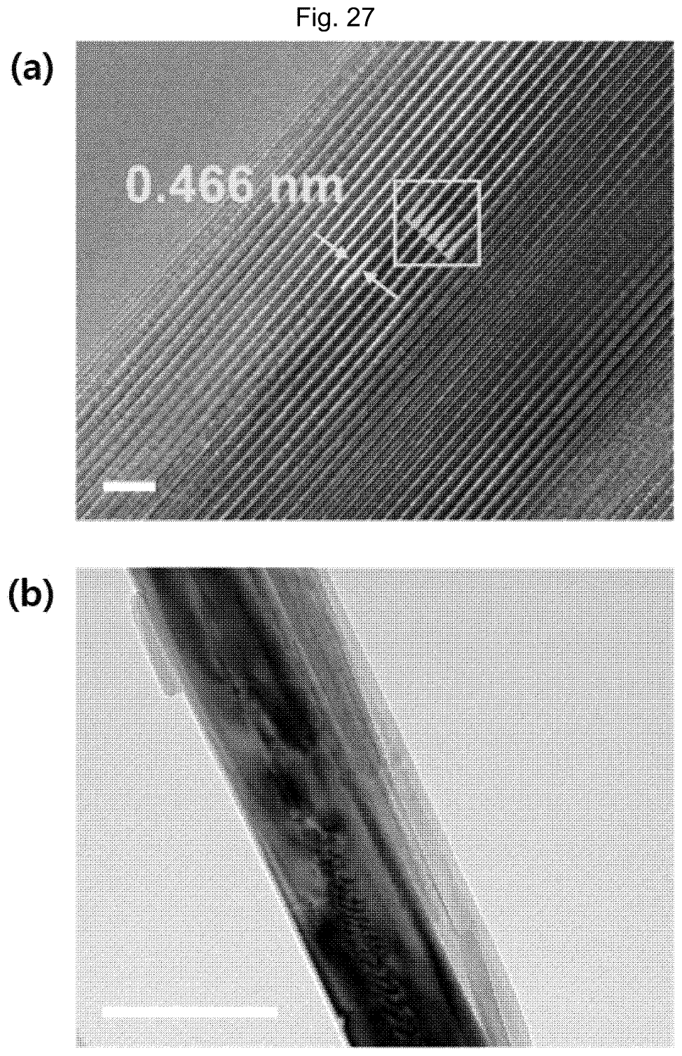

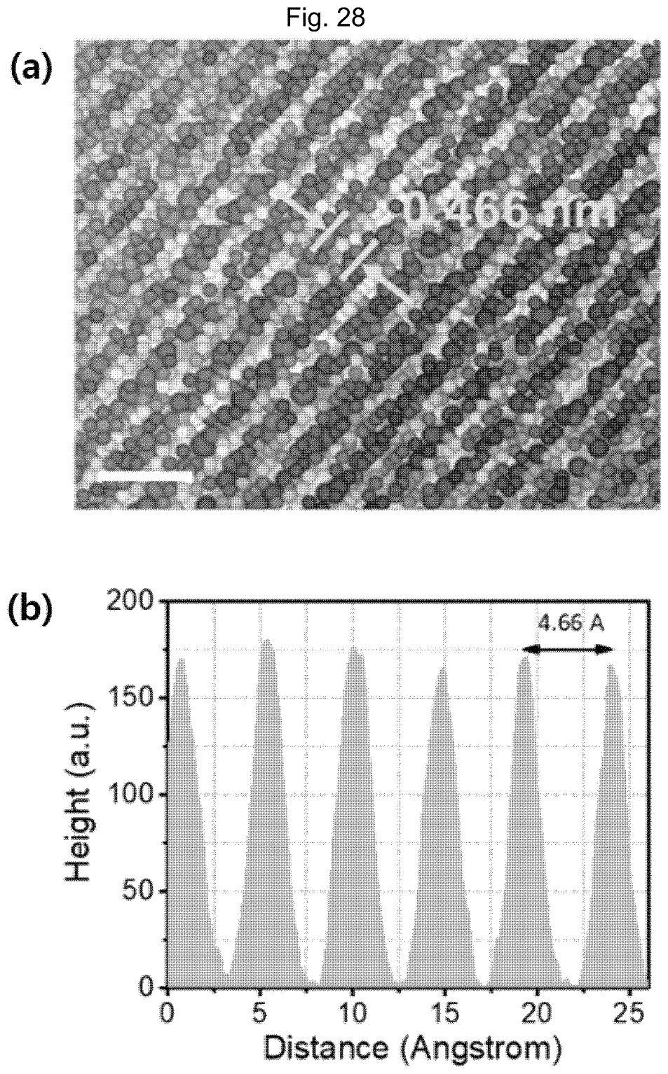

FIG. 26 is a view showing an SEM picture of an electrode structure according to Experimental Example 3 of the present application, FIG. 27 is a view showing TEM pictures of an electrode structure according to Experimental Example 3 of the present application, and FIG. 28 is a view showing a simulation and a lattice fringe image of an atomic structure of an electrode structure according to Experimental Example 3 of the present application.

Referring to FIGS. 26 to 28, SEM and TEM pictures were taken of the CuPS electrode structure (CuP_{0.5}S_{0.5}) according to Experimental Example 3, and a simulation and a lattice fringe image of an atomic structure of an electrode structure were displayed. (a) of FIG. 27 is a high-resolution (scale bar 2 nm) TEM picture of the electrode structure of Experimental Example 3, (b) of FIG. 27 is a low-resolution (scale bar 30 nm) TEM picture of the electrode structure of Experimental Example 3, (a) of FIG. 28 is a simulation showing an atomic arrangement of the crystal plane 101 of the electrode structure of Experimental Example 3, and (b) of FIG. 28 is a topographic plot profile of a lattice fringe image of the electrode structure of Experimental Example 3.

As can be understood from FIG. 26, it can be confirmed that a plurality of fibers form a network in the electrode structure of Experimental Example 3.

In addition, as can be understood from FIGS. 27 and 28, it can be confirmed that a lattice spacing of the electrode structure of Experimental Example 3 is 0.466 nm.

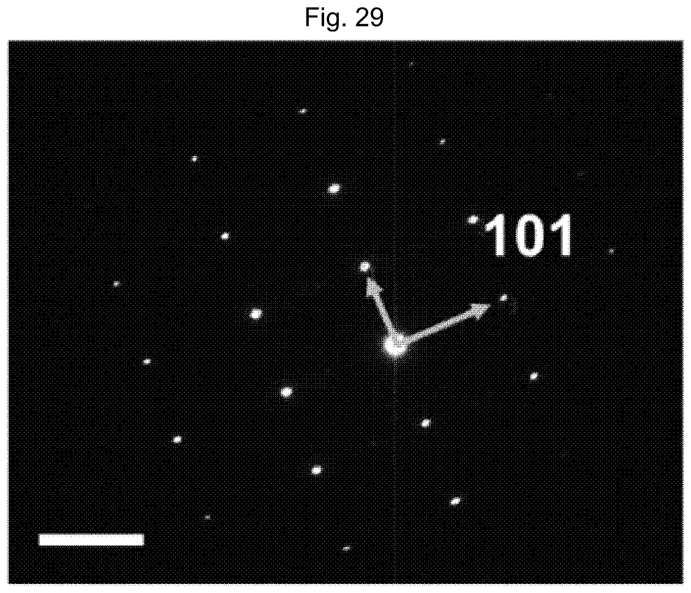

FIG. 29 is a view showing an SEAD pattern of an electrode structure according to Experimental Example 3 of the present application.

Referring to FIG. 29, an SEAD pattern (scale 2 nm⁻¹) for a surface 101 of the CuPS electrode structure (CuP_{0.5}S_{0.5}) according to Experimental Example 3 described above was obtained.

As can be understood from FIG. 29, it can be seen that the electrode structure of Experimental Example 3 has an orthorhombic crystal structure having a crystal plane 101 and is formed of a compound of Cu, P and S.

Although the present invention has been described in detail with reference to exemplary embodiments, the scope of the present invention is not limited to a specific embodiment and should be interpreted by the attached claims. In addition, those skilled in the art should understand that many modifications and variations are possible without departing from the scope of the present invention.

An electrode structure according to an exemplary embodiment of the present application may be utilized in various industrial fields such as a metal-air secondary battery, a lithium ion secondary battery, etc.

What is claimed is:

1. A method for manufacturing a secondary battery, the method comprising:
providing a metal substrate;
surface-treating the metal substrate to form a passivation layer including S and F; and
using the metal substrate on which the passivation layer is formed as a negative electrode to manufacture a secondary battery.

2. The method of claim 1, wherein the passivation layer further comprise N, O and C.

3. The method of claim 1, wherein an SEI layer is formed by using the passivation layer in a process of charging and discharging the secondary battery.

4. The method of claim 1, wherein the passivation layer has a thickness of 20-30 um.

5. The method of claim 1, wherein the metal substrate comprises zinc, and the secondary battery comprises a zinc-air battery.

6. A secondary battery comprising:
a positive electrode;
a negative electrode disposed on the positive electrode and including a metal substrate having a passivation layer including S and F; and
an electrolyte between the positive electrode and the negative electrode.

7. The secondary battery of claim 6, further comprising:
SEI formed by using the passivation layer including S and F in a process of charging and discharging the secondary battery.

8. The secondary battery of claim 6, wherein the passivation layer comprises:
a first passivation layer on a first surface of the metal substrate; and
a second passivation layer on a second surface opposite to the first surface of the metal substrate.

9. The secondary battery of claim 6, further comprising:
a plurality of concave portions provided on a surface of the metal substrate.

10. A method for manufacturing an electrode structure, the method comprising:
mixing trimethylethyl ammonium hydroxide and acetonitrile and adding methyl trifluoromethanesulfonate to prepare Me₃EtNOTF;
dispersing Zn(OTF)₂, Zn(TFSI)₂, and Zn(FSI) in a solvent and adding Me₃EtNOTF to prepare a mixed solution; and
immersing a metal substrate in the mixed solution to form a passivation layer on the metal substrate.

11. The method of claim 10, further comprising:
forming a plurality of concave portions on a surface of the metal substrate by wet-treating or imprinting the metal substrate before immersing the metal substrate in the mixed solution.

12. The method of claim 10, wherein the passivation layer comprises Zn, S and F.
